(19) United States
(12) Patent Application Publication
(10) Pub. No.: US 2018/0268321 A1
(43) Pub. Date: Sep. 20, 2018

(54) MANAGEMENT OF TENANT LOCATIONS IN MULTI-TENANT ENVIRONMENTS

(71) Applicant: CONTACT EFFECT, INC., Everett, WA (US)

(72) Inventors: Thomas James Leafty, Everett, WA (US); Bradley John Redford, Renton, WA (US)

(21) Appl. No.: 15/756,026

(22) PCT Filed: Sep. 1, 2016
(86) PCT No.: PCT/US16/49940

§ 371 Date: Feb. 27, 2018

Related U.S. Application Data
(60) Provisional application No. 62/214,105, filed on Sep. 3, 2015.

(51) Int. Cl. G06Q 10/02; G06F 17/30

(52) U.S. Cl. CPC G06Q 10/02; G06F 17/30876; G06F 17/30241

(57) ABSTRACT

An initial map corresponding to a physical event space may be modified to include a plurality of tenant space segments disposed within a boundary corresponding to the physical event space. Particular tenant space segments may be reserved by event tenants and associated with information descriptive of the event tenants. The customized map may be provided to one or more users of the public (e.g., attendees of the event).

### CROSS-REFERENCE TO RELATED APPLICATIONS

This application is an International Application and claims priority to U.S. Provisional Application Ser. No. 62/214,105, filed Sep. 3, 2015, titled “MANAGEMENT OF TENANT LOCATIONS IN MULTI-TENANT ENVIRONMENTS”, the disclosure of which is incorporated herein by reference in its entirety.

### BACKGROUND

Most physical event spaces are designed to be multi-use. For example, the same convention center may host a technology exhibition one week and a political reception the next. Because of this, aspects of physical event spaces may need to be adjusted or otherwise altered to accommodate the various uses.

### BRIEF DESCRIPTION OF THE DRAWINGS

Various embodiments in accordance with the present disclosure will be described with reference to the drawings, in which:

FIG. 1 illustrates an example block diagram depicting an example flow for managing customized maps in multi-tenant environments, according to at least one example;

FIG. 2 is an example schematic architecture or system for managing customized maps in multi-tenant environments, according to at least one example;

FIG. 3 is an example device for implementing techniques relating to managing customized maps in multi-tenant environments, according to at least one example;

FIG. 4 is a diagram of an example map relating to managing customized maps in multi-tenant environments, according to at least one example;

FIG. 5 is a diagram of an example map relating to managing customized maps in multi-tenant environments, according to at least one example:

FIG. 6 is a diagram of an example map relating to managing customized maps in multi-tenant environments, according to at least one example;

FIG. 7 is a diagram of an example map relating to managing customized maps in multi-tenant environments, according to at least one example;

FIG. 8 is a diagram of an example map relating to managing customized maps in multi-tenant environments, according to at least one example:

FIG. 9 is a diagram of an example map relating to managing customized maps in multi-tenant environments, according to at least one example;

FIG. 10 is a diagram of an example map relating to managing customized maps in multi-tenant environments, according to at least one example;

FIG. 11 is a view of an example user interface relating to managing customized maps in multi-tenant environments, according to at least one example;

FIG. 12 is a view of an example user interface relating to managing customized maps in multi-tenant environments, according to at least one example;

FIG. 13 is a view of an example user interface relating to managing customized maps in multi-tenant environments, according to at least one example;

FIG. 14 is a view of an example user interface relating to managing customized maps in multi-tenant environments, according to at least one example;

FIG. 15 is a view of an example user interface relating to managing customized maps in multi-tenant environments, according to at least one example;

FIG. 16 is a flow diagram depicting example acts for implementing techniques relating to managing customized maps in multi-tenant environments, according to at least one example:

FIG. 17 is a flow diagram depicting example acts for implementing techniques relating to managing customized maps in multi-tenant environments, according to at least one example;

FIG. 18 is a flow diagram depicting example acts for implementing techniques relating to managing customized maps in multi-tenant environments, according to at least one example:

FIG. 18 is a flow diagram depicting example acts for implementing techniques relating to managing customized maps in multi-tenant environments, according to at least one example:

FIG. 19 is a flow diagram depicting example acts for implementing techniques relating to managing customized maps in multi-tenant environments, according to at least one example; and

FIG. 20 is a flow diagram depicting example acts for implementing techniques relating to managing customized maps in multi-tenant environments, according to at least one example.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Examples of the present description are directed to, among other things, techniques relating to managing customized maps in multi-tenant environments. In particular, a digital mapping environment is described, which may be hosted by a map management service. The digital mapping environment includes a set tools and associated functionality for generating, viewing, editing, saving, and otherwise interacting with customized maps of physical spaces that include multiple tenants (e.g., physical events spaces configurable to host multiple tenants). Conventional approaches to map creation rely on draftspersons with sufficient experience and/or training to use computer-aided drafting software to manually create maps. The digital mapping environment described herein is suited for use by many different users without prior experience and/or training. In some examples, the digital mapping environment may be utilized for automated map generation, with little from users. Additionally, use of the digital mapping environment may improve the functioning of the computer by requiring less processing power as compared to conventional approaches that rely on computer-aided drafting applications. This is because such computer-aided drafting applications require a great deal of memory and processing power for suitable operation.

In some examples, the tools and functionality made accessible by the digital mapping environment depends, at least in part, on a profile and/or role of a user who is requesting access to the digital mapping environment. For example, first users (e.g., event owners) may have profiles that enable them to access a map management engine to generate new customized maps by adding and/or removing space segments. Second users (e.g., event attendees) may have profiles that enable them to access the map management engine to view and save information associated with the space segments. This information may be associated with the customized maps by the first users or by other users (e.g., event tenants) by accessing the map management engine. For example, the other users may access the customized maps, reserve one or more tenant segments for use during an upcoming event, and associate concern information with the one or more tenant segments. In some examples, customized map creation is performed in an automated manner on behalf of a user (e.g., an event owner). For example, the user may provide generation parameters, which may be accessed by the map management engine to generate a fully customized map. In this manner, the map may be particularized to the user.

The map management service may include one or more service provider computers, perhaps arranged in a cluster, that include software and/or hardware (e.g., processors, memory, computer-executable instructions, databases, etc.) that are configured to provide one or more webpages, web portals, and or applications to a user device. These may be viewed on the user device via an interface. Thus, the interface may be a web interface, an application programming interface, and any other suitable interface for interacting with the mapping environment. The digital mapping environment may be a combination of software and/or hardware elements.

The map management service may include a map database including a plurality of initial maps. The initial maps may have been previously generated and each may correspond to a particular physical event space and/or to a configuration for a particular physical event space. For example, a first initial map may correspond to a convention center in Seattle, Wash. The first initial map may include a layout of a physical space at the convention center where an event may be conducted. In some examples, the layout may include an exterior boundary that corresponds to an exterior boundary of the physical space and one or more immutable space segments (e.g., fixtures in the physical space, emergency exits, bathrooms, walkways and other areas that are left open for regulatory purposes, and any other segment that is unalterable by the event owner). A second initial map may correspond to a convention center in Tacoma, Wash. and include a different boundary and different immutable space segments. A third initial map may correspond to the convention center in Tacoma, Wash., but include a different layout of the immutable space segments. In this manner, the initial maps may provide graphical representations of physical event spaces.

In response to a request by the event owner, the map management service may present a list on a user interface of a user device that includes at least a portion of the initial maps from the map database. The event owner may select an initial map that corresponds to the physical event space where an upcoming event will be held. By interacting with the functionality provided by the map management service, the event owner may request that the map management service modify parts of the initial map to generate a modified map. This may include modifying the initial map to include a customized layout of tenant space segments, show space segments, seminar space segments, and/or chair space segments within an exterior boundary of the initial map. In some examples, each space segment, whether immutable, tenant, show, seminar, or chair, may correspond to a location within the initial map and have a set of dimensions that may correspond to physical space at the location.

In some examples, the map management service may enable the event owner to adjust the size of certain space segments, adjust the arrangement of certain space segments, adjust attribute information for certain space segments, and perform other suitable operations for customizing the initial map according to one or more modification requests provided by the event owner. The modification requests may be provided via the user interface on the user device.

In some examples, the initial map or other maps may be modified in accordance with owner parameters. The owner parameters may be provided by the event owner, learned from previous interactions with the event owner or other event owners sharing characteristics with the event owner, or obtained in any other suitable fashion. The owner parameters may be used by the map management service in order to streamline the map generation process. For example, the owner parameters may be used to make one or more recommended modifications to an initial map after the owner selects the initial map. These recommended modifications may be based on modifications that other similar event owners generally make at the particular event space. In some examples, the event owner parameters may include: industry associated with the event owner and/or upcoming event, number of expected attendees at event, number of event tenants attending types of events hosted by the event owner, and any other suitable information. In some examples, the event owner may provide one or more owner parameters and the mapping environment may provide a customized map based on the owner parameters. In some examples, this customized map may be generated in a manner that optimizes the layout of space segments within the physical event space. In some examples, the event owner may have full customization control over the initial map. In this later example, the event owner may essentially begin with a “clean slate” from which to design the layout for its upcoming event.

In a particular example, once an event owner has modified an initial map or otherwise caused the map management service to generate a customized map, the customized map may be made available to one or more other users. The other users in this example may be event tenants who are interested in having an event tenant booth at the upcoming event to be hosted by the event owner. In some examples, the map management service, whether via the mapping environment or not, may receive a request from an event tenant to access a customized map. The customized map may include at least an exterior boundary and a plurality of tenant space segments disposed within the boundary. In some examples, the tenant space segments may be formatted differently based on certain information. For example, tenant space segments that have been previously reserved may be formatted in a first manner, while tenant space segments that are available may be formatted in a second manner.

In some examples, each tenant space segment may include one or more interactive elements. The interactive elements may be used to provide additional information regarding the respective tenant space segment (e.g., which event tenant reserved the space segment, a category corresponding to the space segment, and any other suitable information) and to reserve an available tenant space segment. For example, the event tenant may select a particular interactive element which may enable the event tenant to send a reservation request for a particular tenant space segment to the event owner or other entity that is managing the operation of the event. In some examples, the event owner may review information provided by the event tenant via the interactive element and/or other information in order to determine whether the event tenant is approved to reserve the tenant space location. When approved, the event tenant may receive a notification in any suitable manner. In some examples, the approval process for the event tenant may be automated. For example, the event tenant may provide certain information to the map management service, which may be used to pre-approve the event tenant. Thus, when the event tenant sends the reservation request, the event tenant may immediately be notified of its approval.

In some examples, the customized map presented to the event tenant may be further tailored based on information about the event tenant. For example, for a wedding expo event, there may be a variety of types of event tenants wishing to attend (e.g., event tenants with venues, photographers, cakes, invitations, and the like). It may be desirable to locate the different event tenants within the event space based on event tenant type. Thus, if the event tenant is a photographer, the tailored map provided to the event tenant may include “reserved” or unavailable tenant space segments that are located adjacent other photographers. This may be true even if the tenant space segments are not actually reserved. In this manner, the customized map generated by the event owner may be further customized or tailored based on information about a particular event tenant that is viewing the customized map.

In a particular example, once one or more event tenants have reserved their tenant space segments (or even before) in the customized map, the customized map may be made available to one or more other users. The other users in this example may be potential or actual event attendees who may be interested in attending the upcoming event to visit event tenant booths. In some examples, the map management service, whether via the mapping environment or not, may receive a request from an event attendee to access a customized map. The customized map may have previously been customized in accordance with techniques described herein. In some examples, prior to event attendees having access to the customized map (and sending access requests), the event owner may approve the map for publishing. As part of the publication process, the event owner may make one or more changes to the map elements. In some examples, publishing the map may include making the map available to certain portions of the public via a webpage. Returning now to the request to access, in response to the request to access, a version of the customized map may be presented to the event attendee via a user interface of a user device. In some examples, the version of the customized map may include certain interactive elements to enable the event attendee to interact with the customized map. Such interactions may include selecting a tenant space segment to access certain information associated with the tenant space segment. Such information may identify an event tenant associated with the tenant space segment, hours of operation for the event tenant, a type of event tenant associated with the tenant space segment, a description of the event tenant, a webpage of the event tenant, and any other information pertaining to the event tenant and/or the particular tenant space segment (e.g., access directions from certain entrances or other common areas).

In a particular example, the map management service system may include software and/or hardware elements for monitoring and routing event attendee traffic at an event hosted in a physical event space. In some examples, a routing engine may monitor traffic and route traffic with respect to space segments distributed within a customized map. The customized map may be generated in accordance with techniques described herein. In some examples, once the customized map has been generated (or before), one or more paths within the customized map may be identified. In some examples, each path may be associated with a maximum number of human users capable of moving along the respective path. As event attendees in the form of human users visit the event space, wireless network information, mobile network information, or other information may be collected from the user (e.g., from user devices associated with the human users). Such information may be used to identify (generically or specifically) where the users are located within the physical event space. Using this location information, traffic monitoring and routing techniques may be implemented in order to route individual users and/or groups of users from a first destination to a second destination. Routing may be based on the paths and the location information. For example, if a large number of users are located at a stage area, a group of users may be routed to avoid the stage area, even if doing so may not be the most direct route. The routes may be selected in accordance with any selection metric. For example, to minimize time to destination, avoid high traffic areas, and the like. Information about a customized route for a user or a group users may be provided to the users via user devices, provided on one or more display devices within the event space that are near the users (or user devices), or in any other suitable fashion. In some examples, information about a generic route for a user group or all users in the event space may be provided on the one or more display devices. In some examples, each user may receive a customized route according to the user's location within the event space.

In some examples, a route may be generated for an event attendee that may or may not depend on traffic information. For example, an event attendee may select—e.g., via interactive elements on the customized map—a plurality of tenant space segments that the event attendee would like to visit. The routing engine may generate a customized route for the event attendee to visit each of the plurality of tenant space segments. In some examples, the customized route may be optimized according to any suitable parameter. For example, the customized route may seek to minimize time at the event. In some examples, the customized route may be optimized based on information related to the event and the selected tenant space segments. For example, if the event were a wedding expo and the event attendee selected tenant space segments corresponding to a photographer, a venue, a baker, invitations, and a honeymoon service, the customized route may be generated in a manner that is considerate of these selections. For example, based on the selections, the routing engine may route the event attendee in an order that corresponds to when the items will be used with respect to a wedding (e.g., invitations, venue, photographer, baker, and honeymoon service). In some examples, the routing engine may route the event attendee in an order of how other similar users typically purchase such items (e.g., venue, photographer, honeymoon, baker, and invitations). The routing engine may route the event attendee according to other information, in other examples.

In some examples, the map management service may be configured for event owners to create badges for event attendees, sell tickets, and to perform other functions related to hosting the event. This may include advertising and marketing to event tenants and the public. In some examples, the map management service may be configured to track which tenant space segments were visited by which event attendees. For example, each tenant space segment may be outfitted with a device to enable the event attendee to “check-in” at the event tenant's tenant space segment. This may be, for example, a unique code (e.g., a QR code) that can be scanned using a user device, a networked terminal where a user can input his or her information, a tracking beacon that can detect the user device of the event attendee, or any other suitable device for indicating that an event attendee has visited the event tenant's tenant space segment. The map management service may track this information and make it available to the event tenants when requested. In some examples, the event management service may provide access to event tenants and/or event attendees to a network storage location. The event tenants may upload and curate additional information about their offerings. The event attendees may access the additional curated information. In some examples, the map management service may notify an event tenant when a particular customer, after or during the event, accesses the additional curated information corresponding to the event tenant. This may be evidence that the event attendee has an increased interest in the event tenant's offerings.

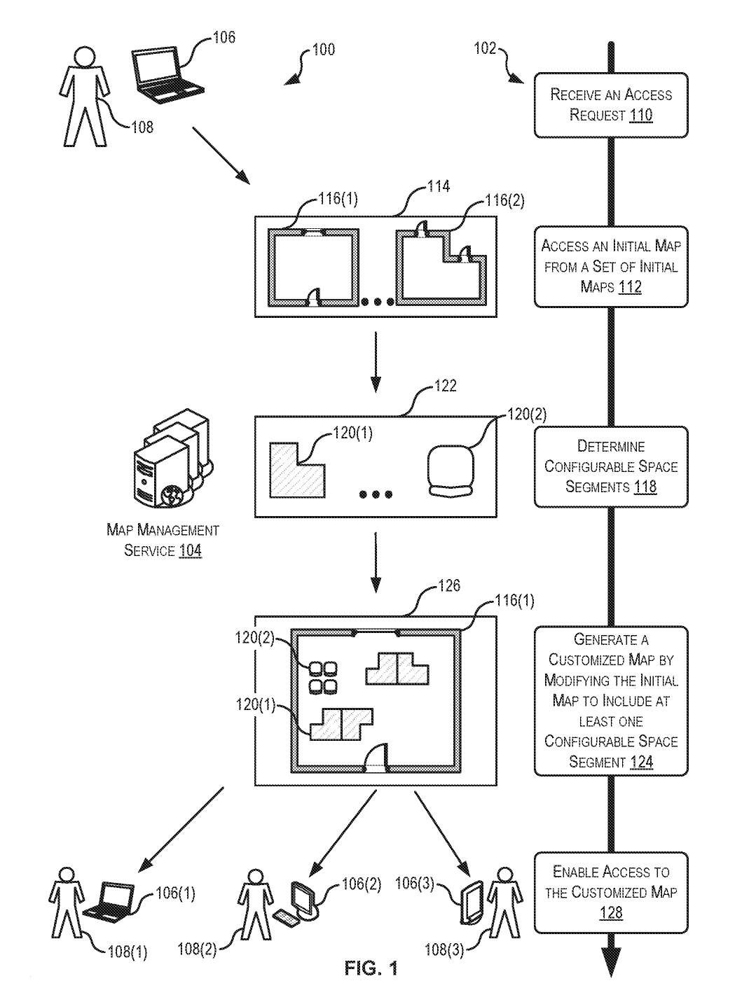

Turning now to the figures, FIG. 1 illustrates an example block diagram 100 depicting an example flow or process 102 for managing customized maps in multi-tenant environments, according to at least one example. The diagram 100 includes a map management service 104, a user device 106, and a user 108. As described herein, the map management service 104 may include any suitable combination of hardware and software resources configured to implement the techniques described herein. For example, the map management service 104 may be a web server configured to provide a web application, a web interface, and the like over one or more networks (e.g., the Internet). Thus, the user 108 may utilize the user device 106 to interact with the map management service 104 using an application, a web interface, and the like via the one or more networks. The map management service 104 may perform the process 102 with or without input from the user device 106.

The process 102 begins at 110 by receiving an access request. The access request may be provided by the user device 106. The access request may request access to information stored on the map management service 104. In some examples, the access requests not only requests access to the information, but also requests that the map management service 104 perform certain functions (e.g., generate a customized map, modify a customized or initial map, associate information with a customized map, add an initial map, view information with a customized map, associated and the like).

At 112, the process 102 accesses an initial map from a set of initial maps 114. The access at 112 may be in response to receiving the access request at 110. For example, the access request may include identifying information that identifies the initial map or identifies a particular physical event space and one or more selection parameters (e.g., size of event, type of event, special needs for event, etc.), which may include owner parameters. In this manner, the map management service 104 may determine which initial map to access from the set of initial maps 114. The set of initial maps 114 may include graphical representations of maps corresponding to different physical event spaces, events of different sizes, events of different types, and the like. Thus, at least some of the initial maps 114 may differ from each other. For example, a first initial map 116(1) may have a square shape, with one door opposite one window. A second initial map 116(2) may have a polygon shape, with two doors on parallel walls. The set of initial maps 114 may each include certain immutable space segments that are not configurable (e.g., walls, windows, bathrooms, doors, power outlets, network access points, drinking fountains, food stands, fire paths, etc.), exterior boundaries and/or may require special privileges to configure. In some examples, the segments of the initial map may include in a first map layer. In some examples, the immutable space segments may also be added to the initial map as a part of map creation. For example, by utilizing a map editing tool in the digital mapping environment.

At 118, the process 102 determines configurable space segments 120 from a set of configurable space segments 122. In some examples, the set of configurable space segments 122 may be located in a second map layer, which may be distinguishable from the first map layer corresponding to the immutable space segments 116. The set of configurable space segments 122 may include graphical representations of certain space segments having predetermined characteristics that can be added to the initial maps in a configurable manner. For example, the configurable space segments may include items such as tenant space segments (e.g., booths) of various sizes, show space segments, seminar space segments, configurable food space segments, configurable bathroom space segments, special attraction segments, chair space segments, and/or other suitable segments. The configurable space segment 120(1) is an example of a tenant space segment, and thus may be associated with a set of characteristics including physical dimensions, access locations, and any other suitable information defining aspects of the configurable space segment 120(1). The configurable space segment 120(2) is an example of a chair space segment, and thus may be associated with a set of characteristics including physical dimensions, suitable use, and any other suitable information defining aspects of the configurable space segment 120(2).

At 124, the process 102 generates a customized map 126 by modifying the initial map to include at least one configurable space segment. For example, the illustrated customized map 126 may include a customized version of the initial map 116(1). This customized map 126 may be generated by selectively associating the configurable space segments 120(1), 120(2) within an exterior boundary of the initial map 116(1). In some examples, the layout of the configurable space segments 120 is selected in a manner that is optimized with respect to some factor. For example, the configurable space segments 120 may be laid out to optimize space within the physical event space (e.g., the initial map 116(1)), to optimize traffic movement of users at the physical event space, to optimize cost of reserving the initial map (e.g., minimize or maximize the cost), to optimize the number of tenant space segments given one or more types of tenant space segments, to optimize the variety of tenant space segments given a set of tenant spaces segments, and to optimize any other factor relating to configuring configurable space segments 120 within the initial map 116 to generate the customized map 126 (e.g., owner parameters).

At 128, the process 102 enables access to the customized map 126. For example, the map management service 104 may send or otherwise allow one or more user devices 106 to access the customized map 126. In some examples, the map management service 104 publishes the map to a public location (e.g., publicly-accessible website) and/or private location (e.g., private website), and the users 108 access the customized map 126 from the public and/or private location. The user 108(1) may be an example of an event owner who uses the user device 106(1) to access the customized map 126. The user 108(2) may be an example of an event tenant who uses the user device 106(2) to access the customized map 126. The user 108(3) may be an example of an event attendee who uses the user device 106(6) to access the customized map 126. In some examples, different users such as administrators of the mapping environment may access the customized map 126. In some examples, the customized map 126 is also made available to those who do not attend the event associated with the customized map 126. For example, the customized map 126 may be provided as part of email to potential attendees, provided at a public location for general public viewing, and the like. In this manner, the customized map 126 may be used to increase attention and attendance to an upcoming event. In some examples, the process 102 also includes associating certain information with the configurable space segments 120 prior to making the customized map 126 available. For example, information about event tenants and their respective tenant locations may be identified on the customized map 126.

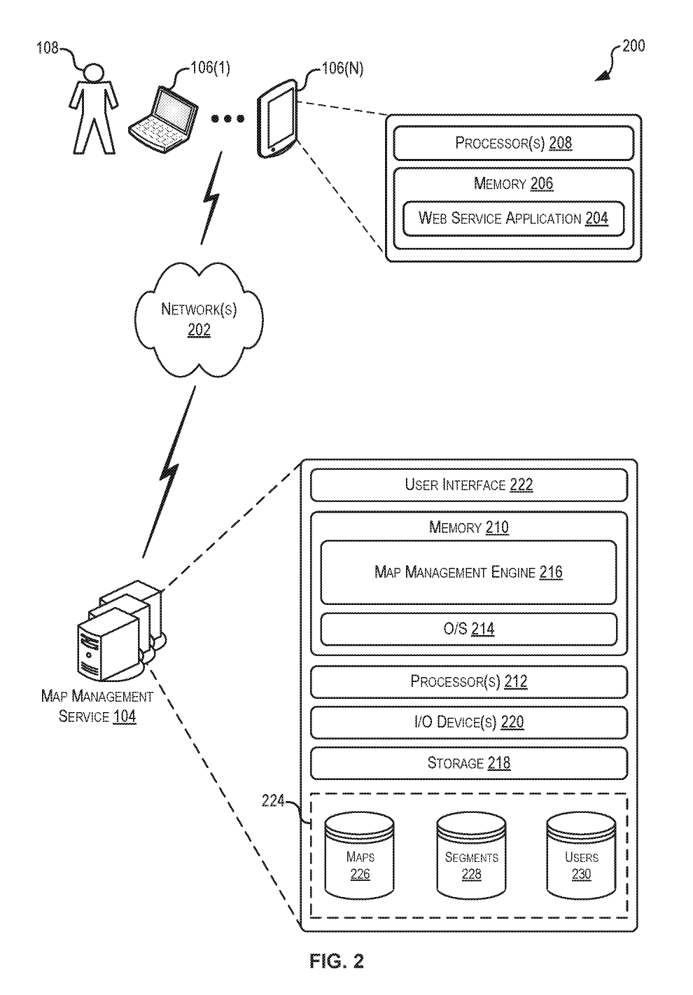

FIG. 2 illustrates an example architecture or system 200 for managing customized maps in multi-tenant environments, according to at least one example. The system 200 may include the map management service 104 in communication with one or more user devices 106(1)-106(N) (hereinafter, “the user device 106”) via one or more networks 202 (hereinafter, “the network 202”). The user device 106 may be operable by one or more users 108 (hereinafter, “the user 108”) to interact with the map management service 104. The network 202 may include any one or a combination of many different types of networks, such as cable networks, the Internet, wireless networks, cellular networks, and other private and/or public networks. The user 108 may be any suitable user including, for example, event owners, event tenants, event attendees, other suitable users associated with the map management service 104, and certain public users.

Turning now to the details of the user device 106, the user device 106 may be any suitable type of computing device such as, but not limited to, a digital camera, a wearable device, a tablet, a mobile phone, a smart phone, a personal digital assistant (PDA), a laptop computer, a desktop computer, a thin-client device, a tablet computer, a set-top box, or any other suitable device capable of communicating with the map management service 104 via the network 202 or any other suitable network. For example, the user device 106(1) is illustrated as an example of a laptop, while the user device 106(N) is illustrated as an example of a smart phone.

The user device 106 may include a web service application 204 within memory 206. Within the memory 206 of the user device 106 may be stored program instructions that are loadable and executable on processor(s) 208, as well as data generated during the execution of these programs. Depending on the configuration and type of user device 106, the memory 206 may be volatile (such as random access memory (RAM)) and/or non-volatile (such as read-only memory (ROM), flash memory, etc.). The web service application 204, stored in the memory 206, may allow the user 108 to interact with the map management service 104 via the network 202. Such interactions may include, for example, searching a database of maps, submitting modification requests, submitting modification parameters, accessing maps, managing user preferences associated with the user 108 and/or any of the user devices 106, and any other suitable client-server interactions. The map management service 104 may host the web service application 204.

Turning now to the details of the map management service 104, the map management service 104 may include one or more service provider computers, perhaps arranged in a cluster of servers or as a server farm, and may host web service applications. These servers may be configured to host a website (or combination of websites) viewable on the user device 106 (e.g., via the web service application 204).

The map management service 104 may include at least one memory 210 and one or more processing units (or processor(s)) 212. The processor 212 may be implemented as appropriate in hardware, computer-executable instructions, software, firmware, or combinations thereof. Computer-executable instruction, software, or firmware implementations of the processor 212 may include computer-executable or machine-executable instructions written in any suitable programming language to perform the various functions described. The memory 210 may include more than one memory and may be distributed throughout the map management service 104. The memory 210 may store program instructions that are loadable and executable on the processor(s) 212, as well as data generated during the execution of these programs. Depending on the configuration and type of memory including the map management service 104, the memory 210 may be volatile (such as random access memory (RAM)) and/or non-volatile (such as read-only memory (ROM), flash memory, or other memory). The memory 210 may include an operating system 214 and one or more application programs, modules, or services for implementing the features disclosed herein including at least a map management engine 216.

The map management service 104 may also include additional storage 218, which may be removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. The additional storage 218, both removable and non-removable, is examples of computer-readable storage media. For example, computer-readable storage media may include volatile or non-volatile, removable or non-removable media implemented in any suitable method or technology for storage of information such as computer-readable instructions, data structures, program modules, or other data. As used herein, modules, engines, and components, may refer to programming modules executed by computing systems (e.g., processors) that are part of the map management service 104 and/or the user device 106.

The map management service 104 may also include input/output (1/O) device(s) and/or ports 220, such as for enabling connection with a keyboard, a mouse, a pen, a voice input device, a touch input device, a display, speakers, a printer, or other I/O device.

The map management service 104 may also include a user interface 222. The user interface 222 may be utilized by an operator or other authorized user to access portions of the map management service 104. In some examples, the user interface 222 may include a graphical user interface, web-based applications, programmatic interfaces such as application programming interfaces (APIs), or other user interface configurations. The map management service 104 may also include a data store 224. In some examples, the data store 224 may include one or more data stores, databases, data structures, or the like for storing and/or retaining information associated with the map management service 104. Thus, the data store 224 may include databases such as a map database 226, a segment database 228, and a user database 230.

The map database 226 may be configured to retain information about maps such as initial maps, customized maps, and any other maps described herein. In some examples, the map database 226 may be used to store characteristics about the maps, and the actual maps may be stored in a different data structure (e.g., the storage 218). The map database 226 may include any suitable number of tables, each including any suitable number of fields. In some examples, the number and type of fields may vary between initial maps and customized maps. For example, initial maps may include fields such as, for example, initial map identifier, event space identifier, event space characteristics (e.g., location in terms of city, state, and address; area (e.g., ft̂2); number of individual spaces; associations with other spaces; reservation and rental prices, etc.), layout templates (e.g., existing, predefined layouts of space segments), space owner characteristics, and any other suitable fields. In some examples, customized maps may include similar fields as the initial maps, but may also include other fields such as, for example, customized map identifier, segment identifiers, layout identifiers, event tenant characteristics (e.g., product offerings, hours, contact information, etc.), and any other suitable fields. Using the fields, the information in the map database 226 may be sorted and accessed using conventional methods.

The segment database 228 may be configured to retain information about space segments that can be added to the maps, whether initial or otherwise. For example, the segment database 228 may include information about straight wall segments, curved wall segments, window segments, pillar segments, doorway segments, stair segments, sign segments, bathroom segments, food segments, check-in segments, concierge segments, medical segments, power outlet segments, network access point segments, fire path segments, drinking fountain segments, tenant space segments, adjustable wall segments, chair segments, seminar space segments, stage space segments, stage accessory space segments, show space segments, seminar space segments, configurable food space segments, configurable bathroom space segments, special attraction segments, chair space segments, and/or any other suitable variety of segment, whether immutable or configurable.

The user database 230 may be configured to retain information about users of the map management service 104. Such users may include event owners, event tenants, event attendees, and others. The user database 230, as appropriate, may store profiles for each of the users in the database. Each profile may include user account information, demographic information about the user, user type (e.g., owner, tenant, attendee, or other), payment information, account preferences for the users, event attendance history, expected event attendance records, and other similar information pertaining to users of the system 200.

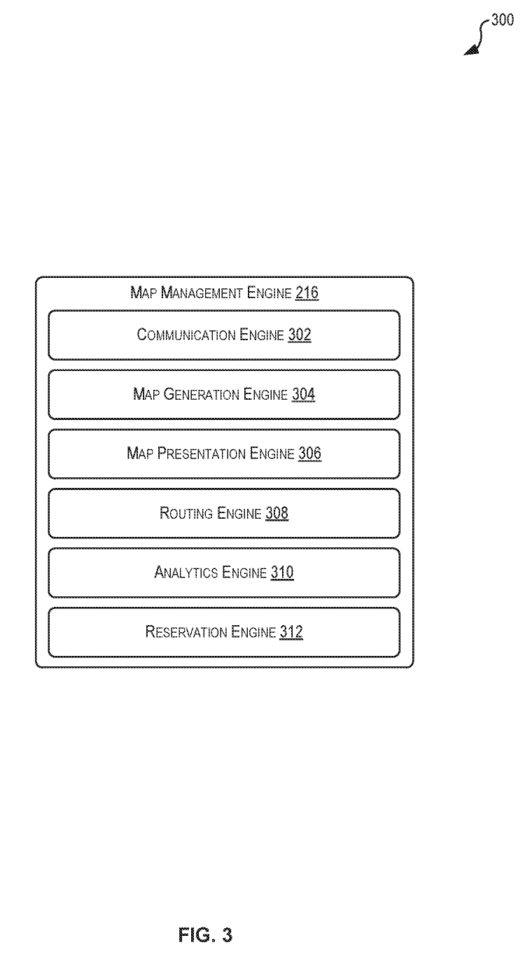

FIG. 3 illustrates an example device 300 including the map management engine 216 for managing customized maps in multi-tenant environments, according to at least one example. The map management engine 216 may be configured to manage one or more sub-engines, modules, components, and/or services directed to examples disclosed herein. In some examples, the map management engine 216 may include a communication engine 302, a map generation engine 304, a map presentation engine 306, a routing engine 308, an analytics engine 310, and a reservation engine 312. While these engines are illustrated in FIG. 3 and will be described as performing discrete tasks with reference to the flow charts, it is understood that FIG. 3 illustrates example configurations and other configurations performing other tasks and/or similar tasks as those described herein may be implemented according to the techniques described herein. Other modules, components, or engines may perform the same tasks as the map management engine 216 or other tasks, they each may be implemented in a similar or different fashion.

The communication engine 302 may be configured to manage communications from other engines of the map management engine 216 and the user devices 106. In some examples, the communication engine 302 may also be configured to authenticate user devices 106 and/or users 108 prior to the users 108 obtaining access to components of the map management service 104. For example, the communication engine 302 may compare login credentials provided by a user 108 with a set of known login credentials to see if the user 108 has a profile with the map management service 104. The communication engine 302 may also include functionality for the users 108 to create new profiles. The communication engine 302 may be used by different types of the users 108 to send different messages. For example, event owners may desire to send automated or manual messages (e.g., email, text, social media, etc.) to event tenants informing them of an upcoming event and inviting them to reserve tenant space segments. Event tenants may desire to send automated or manual messages to possible event attendees prior to the event and to certain event attendees after the event (e.g., attendees that expressed an interest in the offerings of the event tenants). Event attendees may desire to send messages to the event tenants requesting additional information about the event tenants' offerings.

The map generation engine 304 may be configured to enable generation of initial maps and customized maps, as described herein. To this end, the map generation engine 304 may include a map generation tool that may be used for initial map creation (e.g., by an admin) and for customized map creation (e.g., by an event owner). The map generation tool may enable creation of maps having multiple layers. For example, a bottom or first layer may be the initial map that is uploaded. A second layer may include certain immutable space segments (e.g., walls, bathrooms, stairs, etc.). A third layer may include certain configurable space segments (e.g., tenant space segments, chair segments, etc.). A fourth layer may include certain graphical and textual information for marketing purposes (e.g., an event name, sponsors of the event, special advertisers, etc.). The first and second layers may be created by the admin. The third and fourth layers may be created by an event owner and/or in an automated manner by the map generation engine 304. For example, the map generation engine 304 may be configured to maintain a set of map generation rules. The map generation rules may define how the map generation engine 304 can automatically generate customized maps. As part of generating a customized map, the map generation engine 304 may access a set of map generation parameters, at least some of which may be provided by the user 108 (e.g., an event owner). The map generation inputs may define density of tenant space segments, types of space segments required, number of individual tenant space segments, sizes of tenant space segments, and the like. The set of map generation parameters may be used as inputs by the map generation engine 304 as part of evaluating the map generation rules.

The map generation tool may be included as part of a map generation user interface provide by the map generation engine 304. The user interface may be a graphical user interface and configured to provide a window which may be used to create and edit layers of the maps. The graphical user interface may also a palette of various tools for creating and editing the layers of the maps. The graphical user interface may also include a ruler and other graphical elements for assisting a user in the creation and editing of the maps.

The map presentation engine 306 may be configured to enable presentation of the maps to other users by way of publication, sending for presentation at user devices (e.g., rendering on a display device of the user device), and the like. To do so, the map presentation engine 306 may include a map publication tool. Using the map publication tool, the users 108 may be configured to cause the map presentation engine 306 to perform the functions described herein.

The routing engine 308 may be configured to determine and/or predict traffic flows within the physical event space corresponding to a customized map. For example, as part of map generation, the routing engine 308 may process a proposed customized map layout. As part of this processing, the routing engine 308 may identify possible congestion areas, simulate traffic flow patterns, simulate emergency evacuation events, and the like. In this manner, output from the routing engine 308 may help inform customized map generation, in addition to routing user traffic during the events.

The routing engine 308 may also be configured to generate customized routes within physical event spaces corresponding to finalized or otherwise published customized maps. For example, the routing engine 308 may be configured to access location information associated with the user device 106 (e.g., a mobile phone) within a physical event space, and send direction information to the user device 106. The routing engine 308 may generate the direction information based on precomputed routes associated with the customized map (e.g., fastest route from point A to point B) and/or real-time traffic data. For example, the routing engine 308 may receive location information in real-time from user devices 106 present in the physical event space. The routing engine 308 may use this location information to identify areas of congestion, compute routes, and the like. In some examples, the direction information may be provided to public displays within the physical event space, over a speaker system, directly to user devices 106, and/or in any other suitable fashion. When provided in a public manner, the direction information may be considered generic direction information (e.g., applicable to all users). Such generic direction information may be useful to direct traffic around a congested area (e.g., “hang a right to avoid the concert area”), to direct the direction and flow of traffic (e.g., “stay moving forward on the right-hand side of the pathway”), and the like. When provided in a private manner, the direction information may be considered private direction information (e.g., applicable to the user and/or subset of all users that receive the direction information). Such private direction information may be useful to direct a user from a first tenant space segment to a second tenant space segment. The direction information may include a set of turn-by-turn directions presented on the user device 106 or in any other suitable manner. The direction information may be updatable based on the user's real-time location in the physical event space (e.g., the direction information may be recomputed as the user moves through the physical event space).

The analytics engine 310 may be configured to track analytics information pertaining to events. The analytics information may be relevant to event owners, event tenants, and/or event attendees. The analytics engine 310 may be configured to generate analytics reports based on the analytics information and/or present the analytics information in one or more widgets of other updateable graphical user interface elements. For an event owner, the analytics engine 310 may track information such as registered event tenants, activity of registered event tenants, timeline of registered event tenants, revenue related to events, and the like. The analytics engine 310 may also track information at an event level and at a multiple event level. For an event tenant, the analytics engine 310 may track information such as lists of all event attendees, event attendees who visited their tenant space (e.g., based on location information), event attendees that interacted with their tenant space (e.g., by virtually “checking in” to their tenant space on their mobile phone, checking in at a user device at their tenant space, scanning a code at their tenant space (e.g., a QR code), or in any other suitable manner), event attendees that requested additional information, either online or in-person. For an event attendee, the analytics engine 310 may track information such as lists of tenant spaces visited, time spent at each tenant space, check-ins at tenant spaces, and the like.

The reservation engine 312 may be used to manage requests for reservation. For example, the reservation engine 312 may reserve assets such as tenant space segments on behalf of users.

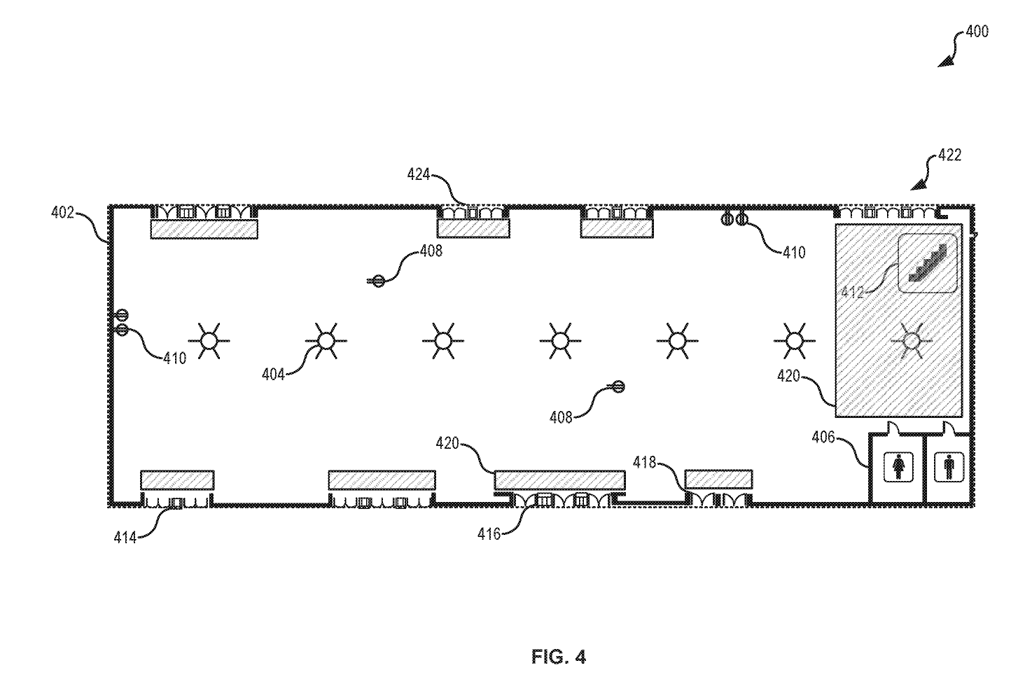

FIG. 4 illustrates an example map 400 relating to managing customized maps in multi-tenant environments, according to at least one example. The map 400 may be provided for presentation via a user interface at a user device of an event owner or to any other suitable user. The map 400 may depict a floor plan (or part of floor plan) of a physical event space 422. In some examples, the map 400 may be considered an initial map and already include a set of immutable space segments such as walls 402, light fixtures 404, bathrooms 406, power outlets 408, network ports 410, stairs 412, first doors 414, second doors 416, third doors 418, open zones 420, and other similar structures, fixtures, and the like that typically remain in the map 400 and are disposed within an exterior boundary 424. Typically, the immutable space segments correspond to real-world items that are not moveable or locations in the map 400 where configurable space segments may not be placed. For example, the bathrooms 406 are not moveable, but, in some examples, maps may include bathrooms that are configurable space segments (e.g., portable restrooms). The open zones 420 are areas in the map 400 that must be left open (e.g., to meet fire code, for traffic flow, etc.). In some examples, the initial map may be created by adding the immutable space segments to a blank map (e.g., one that has no graphical elements) or a basic map (e.g., one that includes only the walls 402 or only the exterior boundary 424 of a building in which the physical event space is housed). To create the map 400, an admin or other authorized user may add the walls 402 and other immutable space segments to a layer of the map 400. These immutable space segments may correspond to the actual physical event space. In some examples, the map 400 is created manually one time and then updated periodically to ensure that it maintains its correct representation of the physical event space. Once created, the map 400 may be reused for generating customized maps. The map 400 may be stored in database and may be associated with the physical event space to which it belongs. As described herein, the database may also include other initial maps similar to the map 400 which correspond to other event spaces or other possible layouts of the same physical event space. If an initial map does not exist for a particular physical event space, the user 108 (e.g., the event owner) may request creation of an initial map. An admin may then create the initial map as requested.

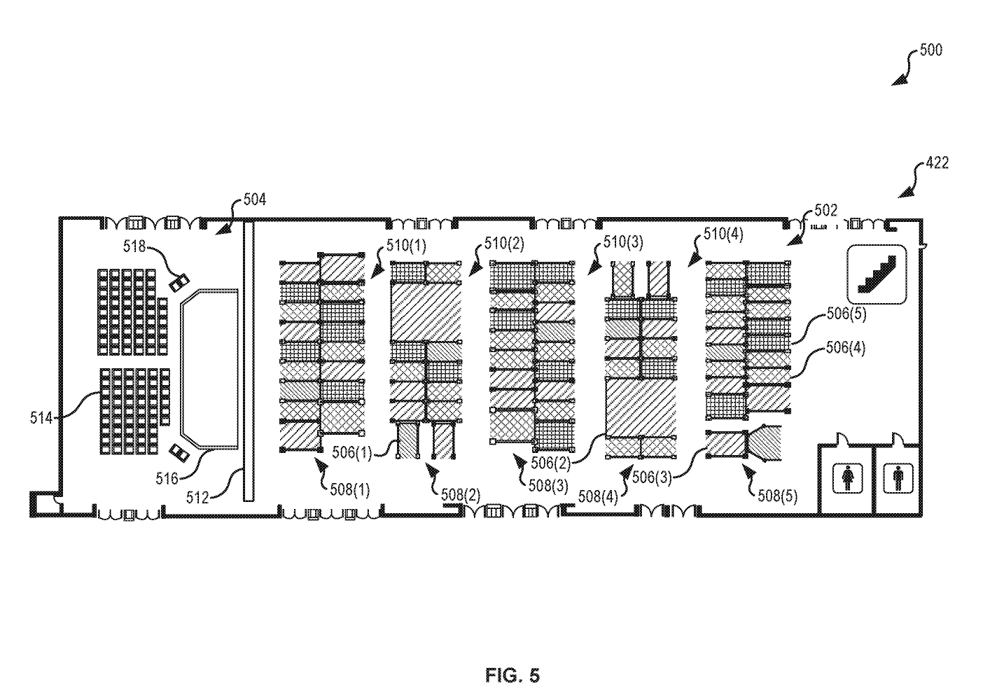

FIG. 5 illustrates an example map 500 relating to managing customized maps in multi-tenant environments, according to at least one example. The map 500 may be provided for presentation via a user interface at a user device of an event owner or to any other suitable user. The map 500 is an example of the map 400 and depicts a floor plan of the physical event space 422. In particular, the map 500 may be considered a customized map because multiple configurable space elements have been laid out in the map 500. As described herein, the customized map may be generated by the map management engine 216 in response to a series of commands issued by a customized map editor (e.g., an event owner). The series of commands may cause placement of the configurable space elements within the floor plan of the map 500.

The map 500 includes a tenant space 502 divided from a stage space 504 by a moveable wall segment 512. The tenant space 502 and the stage space 504 may include configurable space segments. For example, the tenant space 502 includes tenant spaces segments 506 arranged into groups or rows 508(1)-508(5) divided by a group of aisles 510(1)-510(4). The tenant space segments 506, a few of which are labeled 506(1)-506(6), may have any suitable size and shape, and may be oriented within the map 500 in any suitable manner. For example, the tenant space segment 506(1) has a different orientation, size, and shape as compared to the tenant space segment 506(2). The tenant space segments 506 may be arranged in the map 500 using an optimization technique according to some optimization factor (e.g., density, floor space, number of segments, etc.). In this manner, the arrangement (e.g., number of segments, number of aisles, number of groups, arrangement of segments into groups, arrangement of segments within the physical space, etc.) may be optimized.

The stage space 504 may include chair space segments 514, stage space segment 516, and stage accessory space segment 518. Like the space segments in the tenant space 502, the space segments in the stage space 504 may be optimized using any suitable optimization technique according to any suitable optimization factor.

In the view illustrated by the map 500, the tenant space segments 506 may be interactive elements. For example, selecting on one of the tenant space segments 506 may cause a dialog box or other pop-up to present information about the selected tenant space segment 506. Such information may include information about the event tenants associated with the respective tenant space segments 506.

The tenant space segments 506 are depicted as having graphical differences (e.g., hatch fills are different). This may be because the map 500 may be presented to the event owner and the different hatch fill may represent different information associated with the respective tenant space segments 506. For example, the map 500 may represent which event tenants have confirmed the event, but not paid (e.g., the event tenant associated with the tenant space segment 506(1) and others having a similar hatching), which event tenants have not confirmed, and not paid (e.g., the event tenant associated with the tenant space segment 506(2) and others having similar hatching), which event tenants have confirmed and paid (e.g., the event tenant associated with the tenant space segment 506(3) and others having similar hatching), which tenant space segments 506 are still available (e.g., the tenant space segment 506(4)), and any other suitable distinction between tenant space segments 506.

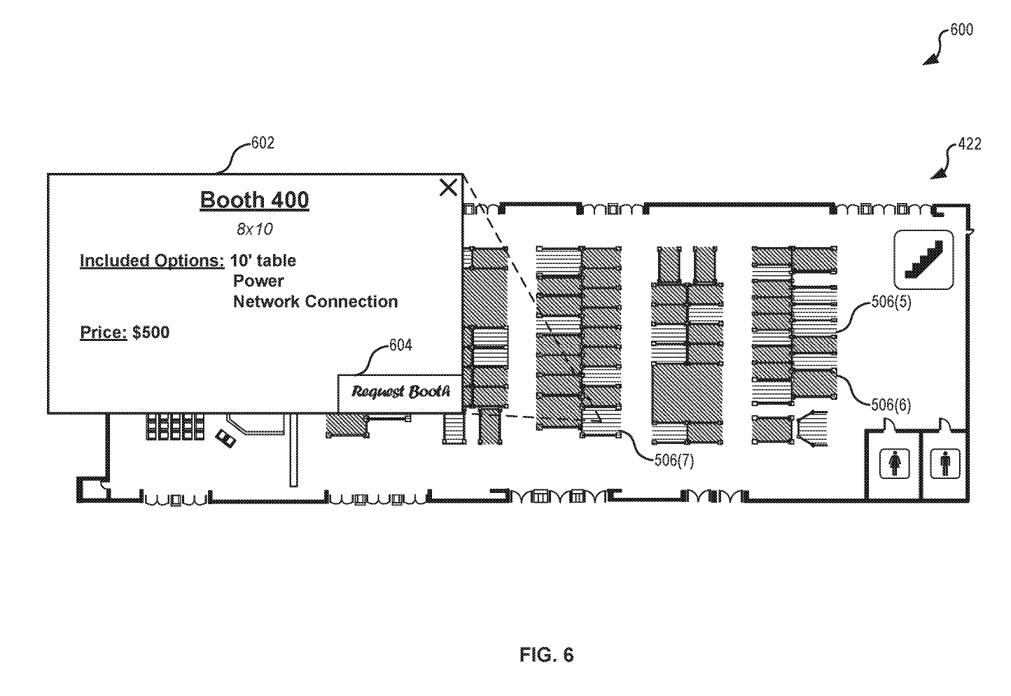

FIG. 6 illustrates an example map 600 relating to managing customized maps in multi-tenant environments, according to at least one example. The map 600 may be provided for presentation via a user interface at a user device of an event tenant or to any other suitable user. The map 600 is an example of the maps 400 and 500 and depicts a floor plan of the physical event space 422. In the view illustrated by the map 600, the tenant space segments 506 are depicted as having graphical differences (e.g., hatch fills are different). This may be because the map 600 may be presented to the event tenant and the different hatch fill may represent different information associated with the respective tenant space segments 506. For example, the map 600 may represent reservation state of the tenant space segments 506. The tenant space segment 506(6)—and those having similar hatching—may represent tenant space segments that are reserved (e.g., an event tenant has reserved the space associated with the tenant space segment by using the map 600 or otherwise). The tenant space segments 506(5) and 506(7)—and those having similar hatching—may represent tenant space segments 506 that are available (e.g., no event tenant has reserved the space associated with tenant space segment).

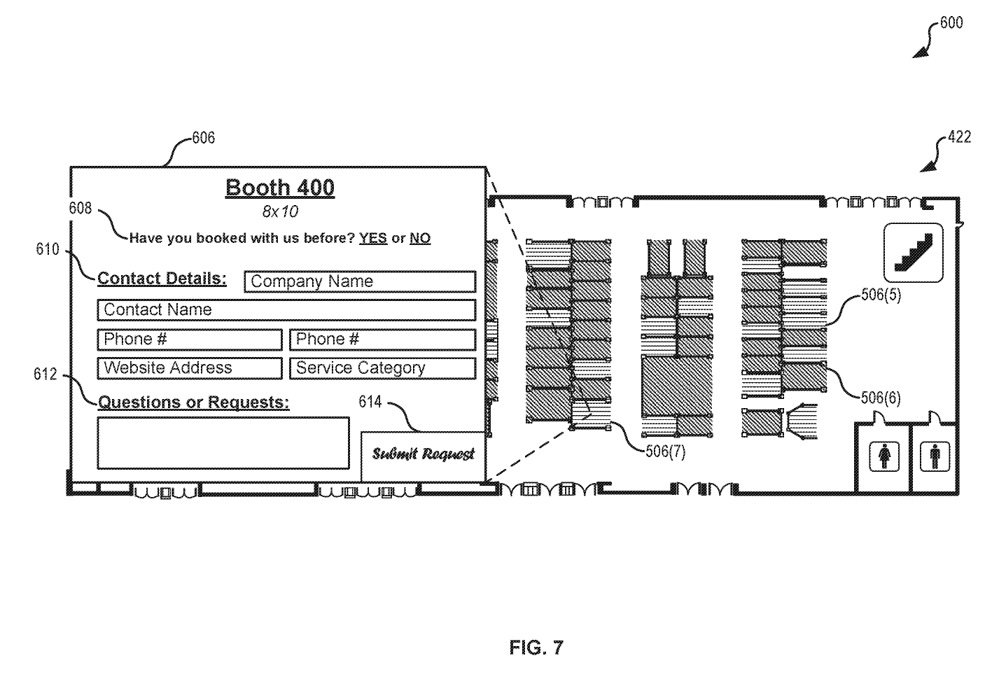

In the view illustrated by the map 600, the tenant space segments 506 may be interactive elements. For example, selecting on one of the tenant space segments 506 may cause some interaction with the map management service 104. As a particular example, the view illustrated in FIG. 6, a dialog box 602 is illustrated. The dialog box 602 corresponds to the tenant space segment 506(7), and may be presented after a user selects the tenant space segment 506(7) (e.g., using a mouse or other input device to select the tenant space segment 506(7)). The dialog box 602 may present information associated with the tenant space segment 506(7). Thus, the dialog box 602 includes a booth number (e.g., Booth 400), a booth size (e.g., 8×10), options included in a reservation (e.g., 10′ table, power connection, and network connection), and a price (e.g., $500). Other information may also be presented in the dialog box 602. If the user viewing the map 600 (e.g., an event tenant) desires to book the tenant space associated with the tenant space segment 506(7), the user may select a booking selector 604 (e.g., Request Booth). Selecting the booking selector 604 may cause a booking request dialog box to be provided, as illustrated in FIG. 7.

FIG. 7 illustrates the map 600 and a dialog box 606. The dialog box 606 may be presented in response to the user selecting the selector 604. The dialog box 606 may be used to receive information from the user relating to reserving the tenant space segment 506(7). In particular, the dialog box 606 may ask whether the user has booked previously 608. If yes, the contact data fields 610 and requests field 612 may auto populate with stored information. If no, the user may be prompted to input information into the contact data fields 610 and the requests field 612. After finishing, the user may select booking request selector 614. This may cause a booking request to be sent to the map management service 104. The map management service 104 may automatically evaluate the event tenant (e.g., based on a profile associated with the event tenant and/or the information input in the dialog box 606) and determine whether to grant the booking request. In some examples, an administrator associated with the event owner may manually evaluate booking requests.

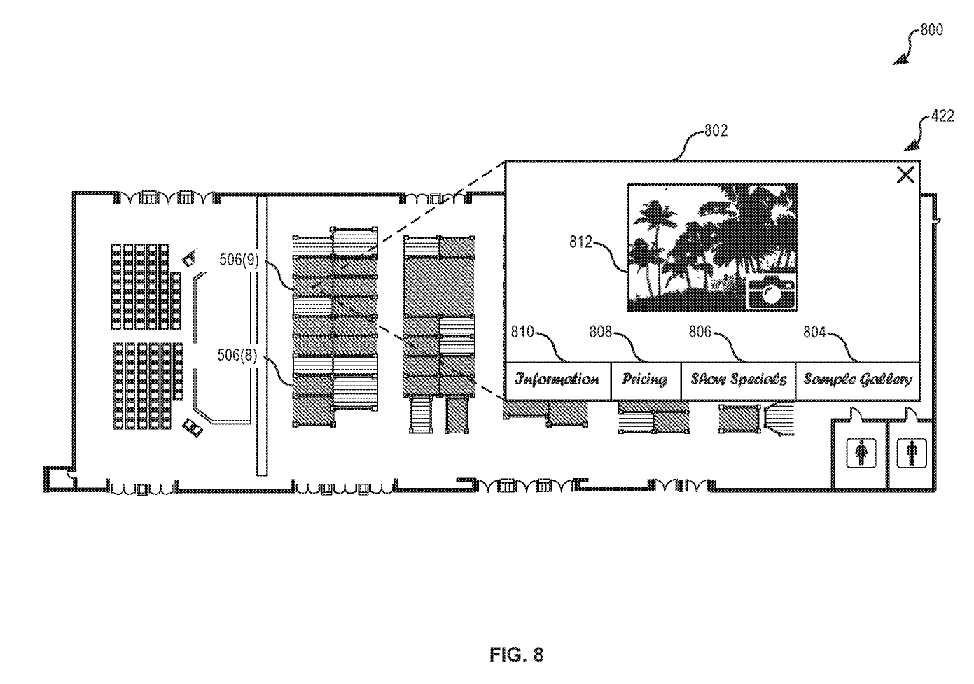

FIG. 8 illustrates an example map 800 relating to managing customized maps in multi-tenant environments, according to at least one example. The map 800 may be provided for presentation via a user interface at a user device of an event attendee or to any other suitable user. The map 800 is an example of the maps 400, 500, and 600 and depicts a floor plan of the physical event space 422.

In the view illustrated by the map 800, the tenant space segments 506 may be interactive elements. For example, selecting one of the tenant space segments 506 may cause some interaction with the map management service 104. As a particular example, the view illustrated in FIG. 8, a dialog box 802 is illustrated. The dialog box 802 corresponds to the tenant space segment 506(9), and is presented in response to the event attendee selecting the tenant space segment 506(9). The dialog box 802 may be used to present information about a tenant associated with the tenant space segment 506(9). In this example, the tenant is a photographer. It is understood, however, that the information and options for presenting such information may be different for different types of event tenants. This information may be relevant to the event attendee for purposes of planning or for any other purpose.

The dialog box 802 may include a plurality of selectors 804-810, the selection of any one of which will change the information presented in the dialog box 802. The gallery selector 804 may enable access to a gallery of photographs 812, i.e., as illustrated. The show special selector 806 may enable access to a list of special good or service offerings associated with the upcoming event. The pricing selector 808 may enable access to a price list for goods or services offered by the event tenant. The information selector 810 may enable access to information about the event tenant (e.g., contact information, web address, email address, biography, etc.).

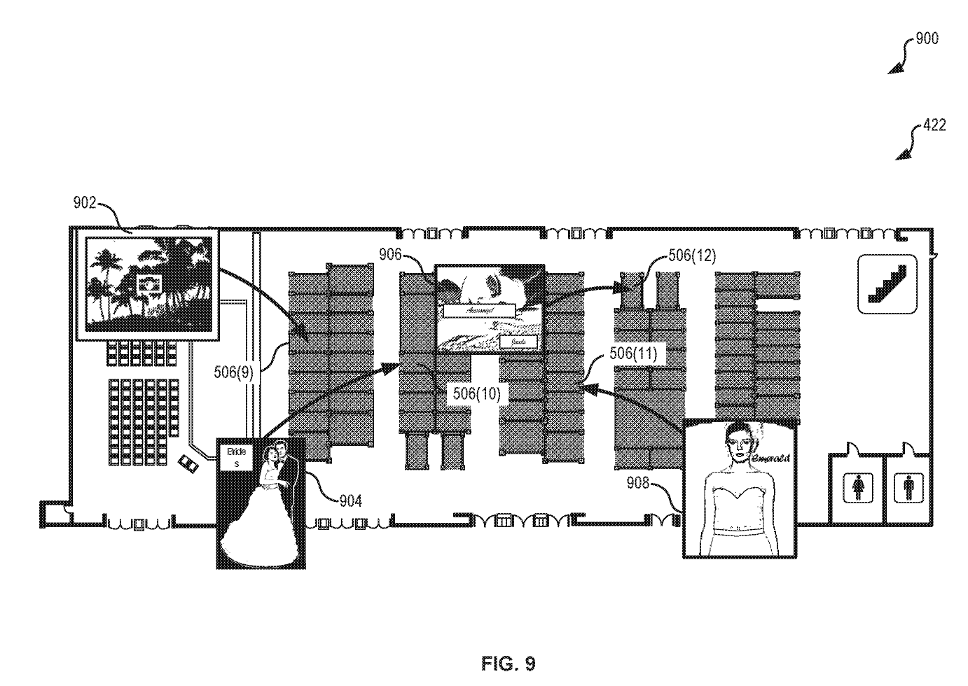

FIG. 9 illustrates an example map 900 relating to managing customized maps in multi-tenant environments, according to at least one example. The map 900 may be provided for presentation via a user interface at a user device of an event attendee or to any other suitable user. The map 900 is an example of the maps 400, 500, 600, and 800 and depicts a floor plan of the physical event space 422.

In the view illustrated by the map 900, the tenant space segments 506 may be interactive elements. For example, selecting one of the tenant space segments 506 may cause some interaction with the map management service 104. As a particular example, in the view illustrated in FIG. 9, pin markers 902-908 are illustrated. The pin markers 902-908 provide a minimum amount of information about the event tenants associated with the respective tenant space segments 506. The user can user the pin markers 902-908 to pin the tenant space segments 506 how they would like to see them on the map 900. In this example, the map management service 104 may store information about which tenant space segments 506 the user stored and, in some examples, the order of the pin markers 902-908. In this example, the user may have searched for the particular event tenants by sorting the map 900 based on category (e.g., photographers, venues, jewelry, and dresses) and selecting the particular event tenants from the sorted group. In this example, the pin marker 902 corresponds to an event tenant from the category of photographers, the pin marker 904 corresponds to an event tenant from the category of venues, the pin maker 906 corresponds to an event tenant from the category of jewelry, and the pin marker 908 corresponds to an event tenant from the category of dresses.

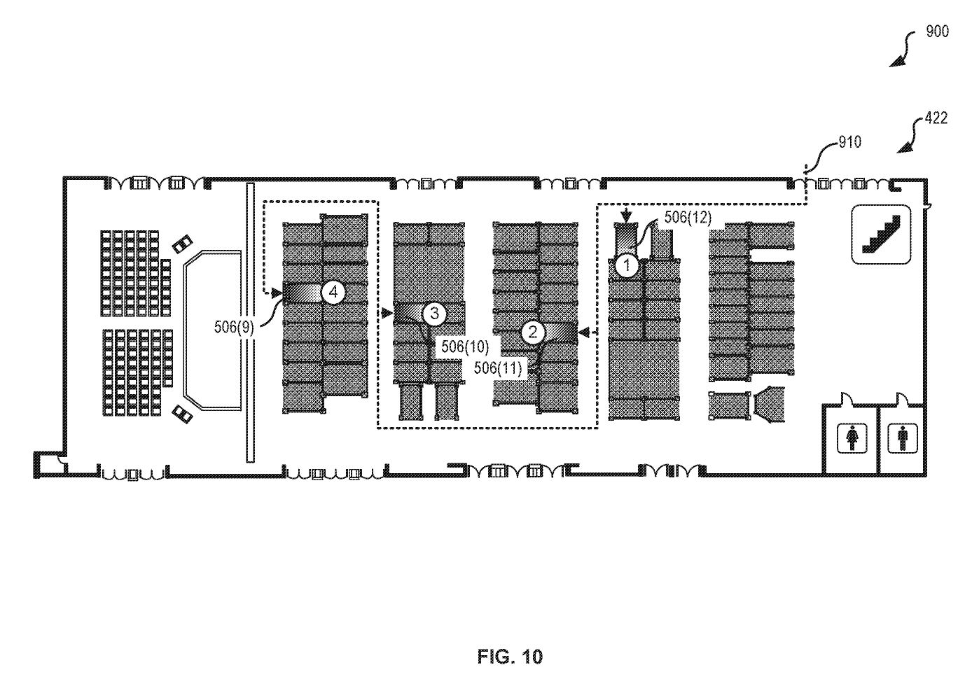

FIG. 10 illustrates a view of the map 900. The map 900 may also be presented to the event attendee on a user device such as a mobile device. In some examples, the pin markers 902-908 illustrated in FIG. 9 may be used to chart a route 910 through the tenant space segments 506. For example, the route 910 may be automatically determined for entering the physical event space 422 and visiting each of the tenant space segments 506(12), 506(11), 506(10), and 506(9). In this example, the visits may be ordered (e.g., 1, 2, 3, and 4). In some examples, the user may manually edit the order of the visits. The route 910 may be generated by the routing engine 308.

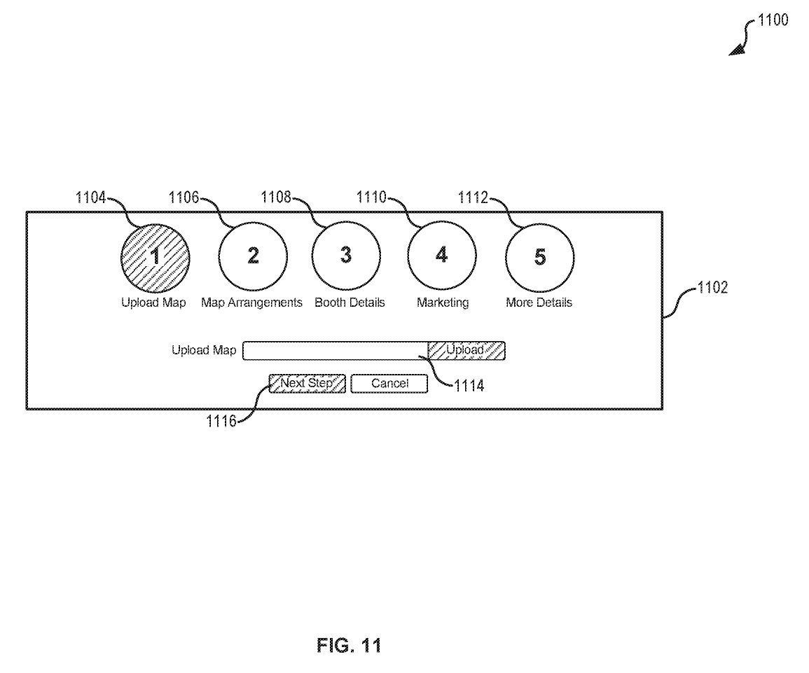

FIGS. 11-15 illustrate example user interfaces 1100, 1200, 1300, 1400, and 1500 relating to managing customized maps in multi-tenant environments, according to various examples. The user interfaces 1100, 1200, 1300, 1400, and 1500 may be presented as graphical user interfaces on a display of a user device, as described herein. The user interfaces 1100, 1200, 1300, 1400, and 1500 may correspond to a process for an event owner to generate an initial map and a customized map. For example, the user interfaces 1100 and 1200 may be used to generate the initial map, while the user interfaces 1300, 1400, and 1500 may be used to generate the customized map.

Turning now to FIG. 11, FIG. 11 illustrates, the user interface 1100 that includes a window 1102. The window 1102 includes status elements 1104-1112, upload area 1114, and next selector 1116. The status elements 1104-1112 may indicate a status of map generation. Thus, the status elements 1104-1112 may include an upload status element 1104, a map arrangement status element 1106, a booth detail status element 1108, a marketing status element 1110, and a more details status element 1110. The user interface 1100 may be used to fulfill functions relating to the upload status. Thus, the upload status element 1104 is highlighted. Using the upload area 1114 the user may select a blank map or a basic map for uploading to the map management service 104. In some examples, the upload area 1114 may be used to select an existing map from the map database in the map management service 104. Once the user has selected an appropriate map, the user may select the next selector 1116 to move to the next user interface (e.g., 1200).

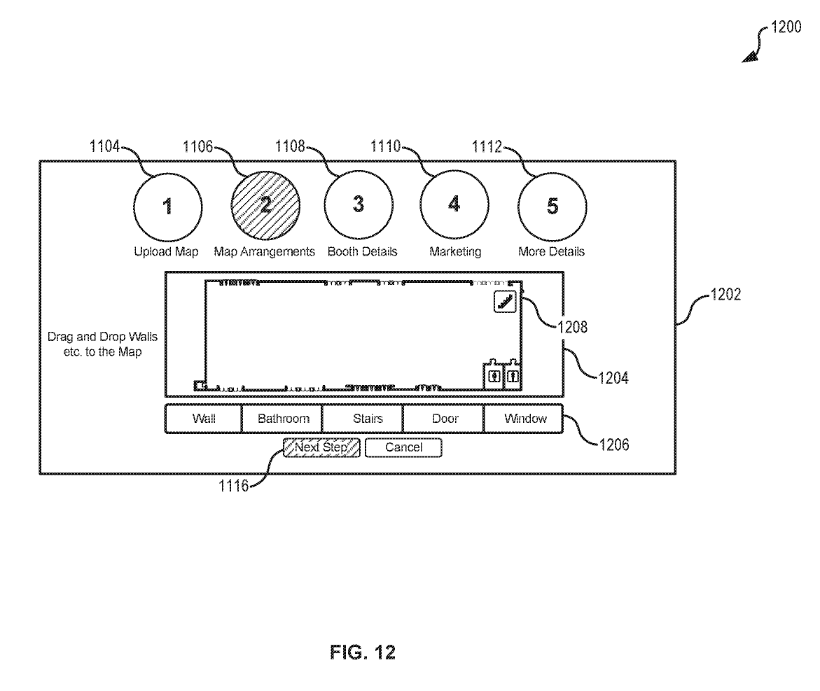

Turning now to FIG. 12, FIG. 12 illustrates the user interface 1200 that includes a window 1202. The window 1202 includes an editing space 1204, a set of edit immutable segment selectors 1206, the status elements 1104-1112, and the next selector 1116. The user interface 1200 may be used to fulfill functions relating to arranging immutable space segments. Thus, the map arrangement status element 1106 is highlighted. Within the editing space 1204 is included a map 1208 corresponding to a physical space. In particular, the map 1208 may have been selected using the user interface 1100. Using the user interface 1200, the user may edit the map 1208 by adding immutable space segment such as those included in the edit immutable segment selectors 1206 (e.g., walls, bathrooms, stairs, doors, windows, and others as described herein). In some examples, the user may drag and drop such segments into the editing space 1204 to add them to the map 1208. Once the user has modified the map 1208 sufficiently, the user may select the next selector 1116 to move to the next user interface (e.g., 1300).

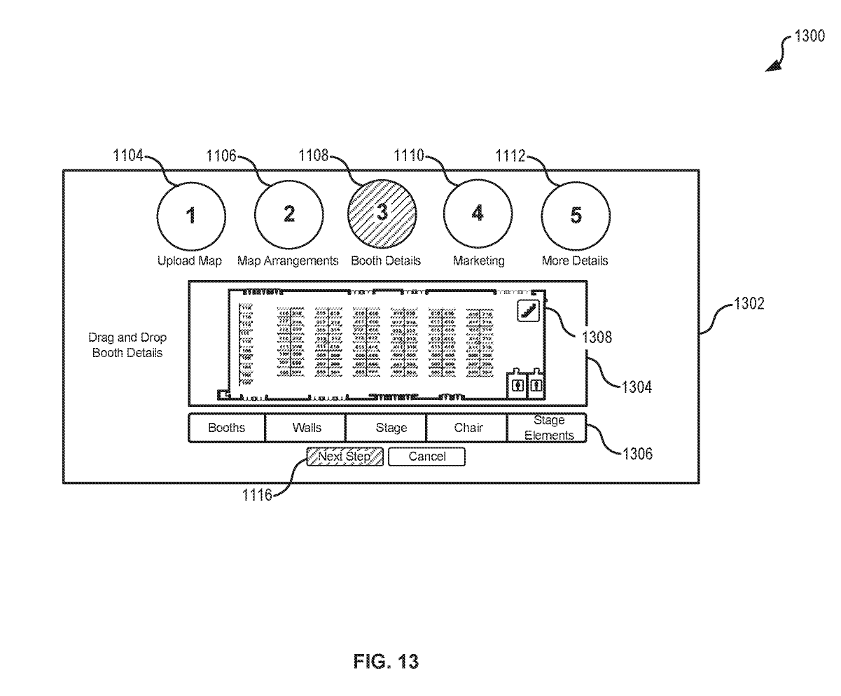

Turning now to FIG. 13, FIG. 13 illustrates the user interface 1300 that includes a window 1302. The window 1302 includes an editing space 1304, a set of edit configurable space segment selectors 1306, the status elements 1104-1112, and the next selector 1116. The user interface 1300 may be used to fulfill functions relating to arranging configurable space segments. Thus, the booth details status element 1108 is highlighted. Within the editing space 1304 is included a map 1308 corresponding to a physical space. The map 1308 may be a later version of the map 1208. In particular, the user may edit the map 1208 to generate the map 1308 by adding configurable space segments such as those included in the edit configurable space segment selectors 1306 (e.g., booths, walls, stage, chair, stage elements, and others as described herein). In some examples, the user may drag and drop such segments into the editing space 1304 to add them to the map 1308. Once the user had modified the map 1308 sufficiently, the user may select the next selector 1116 to move to the next user interface (e.g., 1400).

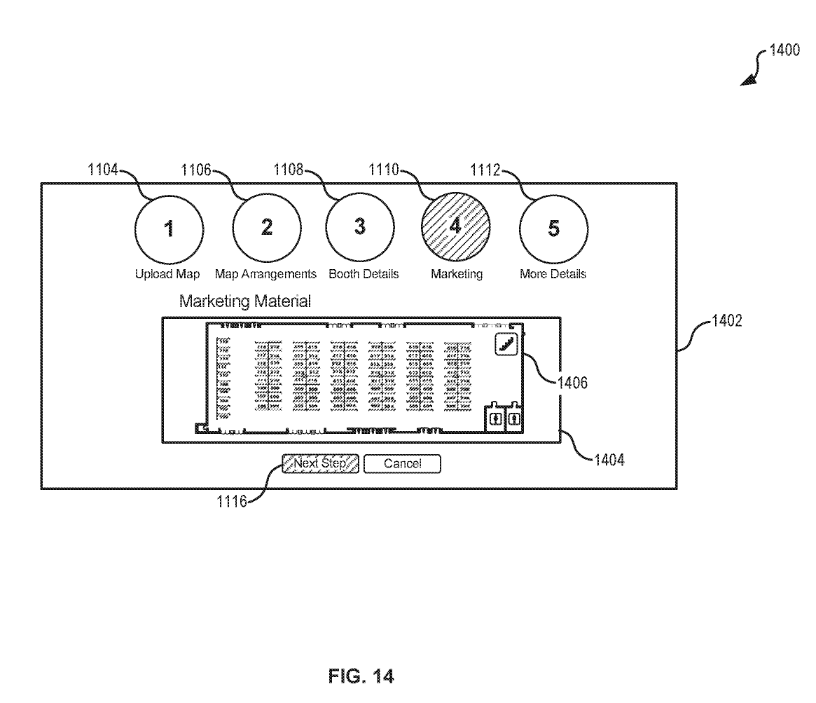

Turning now to FIG. 14, FIG. 14 illustrates the user interface 1400 that includes a window 1402. The window 1402 includes an editing space 1404, the status elements 1104-1112, and the next selector 1116. The user interface 1400 may be used to fulfill functions relating to adding marketing materials to the map 1308 to create a map 1406. Thus, the marketing status element 1110 is highlighted. Within the editing space 1404 is included the map 1406 corresponding to a physical space. The map 1406 may be a later version of the map 1308. In particular, the user may utilize the user interface 1400 to add marketing materials to the map 1308 to generate the map 1406. The marketing materials may include information associated with an event owner, event tenants, sponsors, and any other suitable entities. Once the user has modified the map 1406 sufficiently, the user may select the next selector 1116 to move to the next user interface (e.g., 1500).

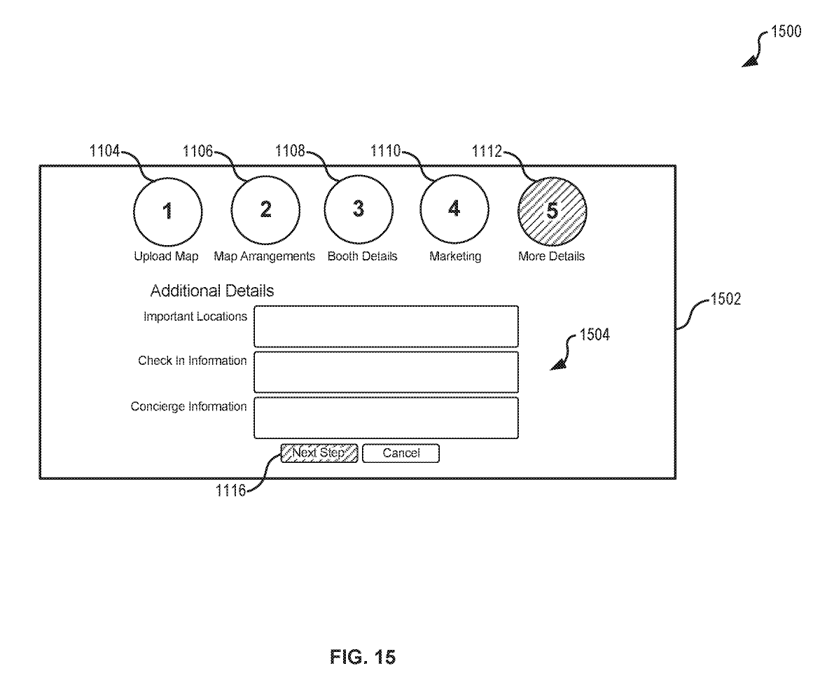

Turning now to FIG. 15, FIG. 15 illustrates the user interface 1500 that includes a window 1502. The window 1502 includes additional detail boxes 1504, the status elements 1104-1112, and the next selector 1116. The user interface 1500 may be used to fulfill functions relating to associating additional information with the map 1406. Thus, the details status element 1112 is highlighted. In particular, the user may use the user interface 1500 to add additional information relating to the upcoming event, e.g., the event for which the map 1406 was generated.

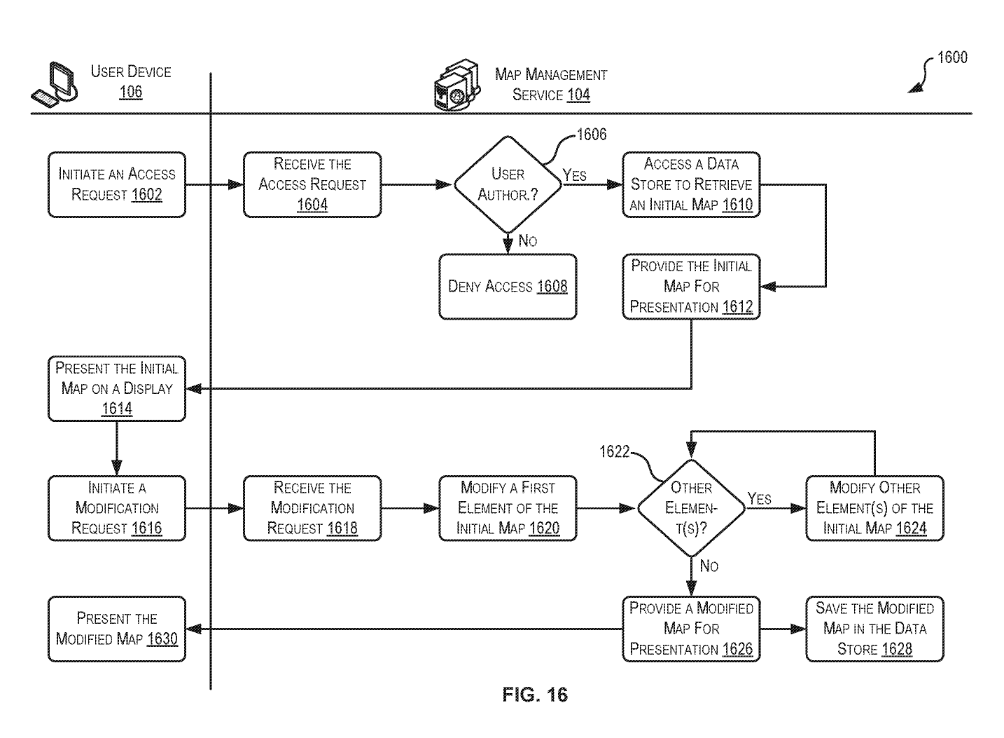

FIGS. 16, 17, 18, 19, and 20 illustrate example flow diagrams showing respective processes 1600, 1700, 1800, 1900, and 2000, as described herein. These processes 1600, 1700, 1800, 1900, and 2000 are illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement the processes.

Additionally, some, any, or all of the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium is non-transitory.

FIG. 16 depicts the process 1600 including example acts or techniques relating to managing customized maps in multi-tenant environments, according to at least one example. The map management engine 216 (FIG. 2) within the map management service 104 (FIG. 1) and in communication with one or more user devices 106 (FIG. 1) may perform the process 1600 of FIG. 16. The process 1600 begins at 1602 by initiating an access request. This may be performed by the user device 106. In some examples, an event owner operates the user device 106 to initiate the access request. The access request may request access to one or more assets of the map management service 104. For example, the access request may request access to a digital mapping environment in which the event owner can modify and/or generate event maps for upcoming events. The access request may identify the user associated with the user device 106 by way of a unique user identifier. In some examples, prior to sending the access request, the user may have signed into a website hosted by the map management service 104. In this manner, the map management service 104 may be able to identify the user based on the access request.

At 1604, the process 1600 receives the access request. This may be performed by the communication engine 302 (FIG. 3). The access request may be received from the user device 106. As described above, the map management service 104 may be capable of identifying the user based on the access request. This may include comparing identifying information from the access request with a table of similar information (e.g., the user profile).

At 1606, the process 1600 determines whether the user is authorized to access the assets requested by the access request. This may be performed by the communication engine 302. Determining whether the user is authorized may include determining whether a user profile exists for the user (e.g., is this a recognized user) and using the user profile to determine what privileges are associated with the user.

If the determination at 1606 is that the user is not authorized (e.g., the answer is NO), the process 1600 proceeds to 1608 and denies access to the asset. This may be performed by the communication engine 302. As part of denying access, the process 1600 may send a communication to the user device that informs the user why the access request has been denied. For example, the communication may inform the user that the user lacks certain privileges to access the asset.

If the determination at 1606 is that the user is authorized (e.g., the answer is YES), the process 1600 proceeds to 1610 and accesses a data store to retrieve an initial map. This may be performed by the map presentation engine 306 (FIG. 3). Determining which initial map to access may be based at least in part on information in the access request. For example, the access request may identify a location (e.g., Seattle) for which event maps are required. In some examples, the access request includes a more specific identifier (e.g., room 3B at the Seattle Convention Center).

At 1612, the process 1600 provides the initial map for presentation. This may be performed by the map presentation engine 306. Providing the initial map may include sending information about the initial map for rendering at the user device 106.

At 1614, the process 1600 presents the initial map on a display. This may be performed by the user device 106.

At 1616, the process 1600 initiates a modification request. The modification request may be generated at the user device 106 by a user interacting with a user interface by which the initial map is presented. For example, the initial map may be presented in a map editing window and the modification request may include a request to add or remove a configurable space segment to or from the initial map.

At 1618, the process 1600 receives the modification request. This may be performed by the communication engine 302.

At 1620, the process 1600 modifies a first element of the initial map. This may be performed by the map generation engine 304 (FIG. 3). Modifying the first element of the initial map may include adding or removing a configurable space segment. For example, modifying the first element may include laying out a first set of tenant space segments. In some examples, modifying the first element may include adding or removing an immutable space segment.

At 1622, the process 1600 determines whether there are other elements to modify. This may be performed by the map generation engine 304. For example, the modification request may request addition, whether manually or programmatically, of a set of configurable space elements (e.g., a set including tenant space segments, seminar space segments, chair space segments, and the like). Thus, the process 1600 may determine whether other elements should be modified, which again may include adding to the initial map, removing from the initial map, and/or changing existing elements in the initial map.

If the determination at 1622 is that there are other elements (e.g., the answer is YES), the process 1600 proceeds to 1624 and modifies the other elements of the initial map. In this manner, the process 1600 may be iterative in modifying elements. Certain first elements may be modified (e.g., added to the initial map), followed by certain second elements. In some examples, the modifications of the second elements may depend on the modifications of the first elements.

If the determination at 1622 is that there are no other elements (e.g., the answer is NO), the process 1600 proceeds to 1626 and provides a modified map for presentation. This may be performed by the map presentation engine 306. The modified map, in some examples, may be considered a customized map because it has been generated in part based the modification request input by the user.

At 1628, the process 1600 saves the modified map in the data store. This may be performed by the map generation engine 304. In this manner, the modified may be made available to other users in the future. For example, certain other users may search the data store for maps of the same region. If the modified map meets their requirements, they request access to reuse the modified map for their events. In some examples, these other users may also use a process similar to the process 1600 to modify the modified map.

At 1630, the process 1600 presents the modified map. This may be performed by the user device 106.

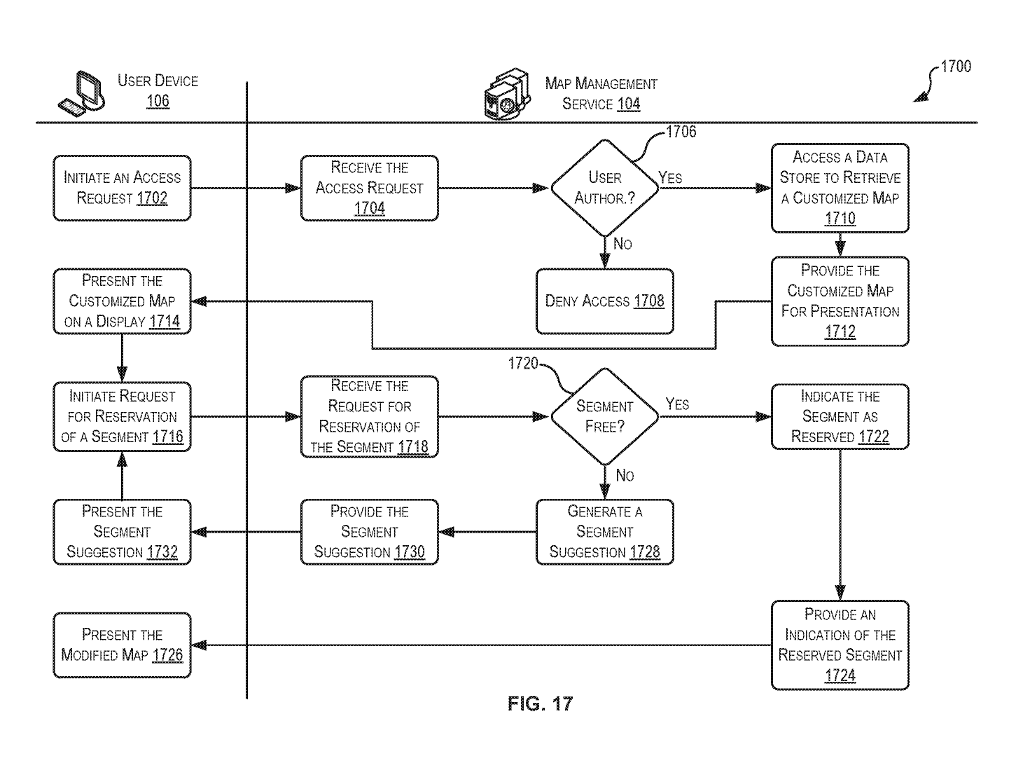

FIG. 17 depicts the process 1700 including example acts or techniques relating to managing customized maps in multi-tenant environments, according to at least one example. The map management engine 216 (FIG. 2) within the map management service 104 (FIG. 1) and in communication with one or more user devices 106 (FIG. 1) may perform the process 1700 of FIG. 17. The process 1700 begins at 1702 by initiating an access request. This may be performed by the user device 106. In some examples, an event tenant operates the user device 106 to initiate the access request. The access request may request access to one or more assets of the map management service 104. For example, the access request may request access to a digital mapping environment in which the event tenant can reserve a tenant space segment for an upcoming event, create, and/or modify a profile associated with the tenant, and perform certain administrative operations relating to upcoming events. The access request may identify the user associated with the user device 106 by way of a unique user identifier. In some examples, prior to sending the access request, the user may have signed into a website hosted by the map management service 104. In this manner, the map management service 104 may be able to identify the user based on the access request.

At 1704, the process 1700 receives the access request. This may be performed by the communication engine 302 (FIG. 3). The access request may be received from the user device 106. As described above, the map management service 104 may be capable of identifying the user based on the access request. This may include comparing identifying information from the access request with a table of similar information (e.g., the user profile).

At 1706, the process 1700 determines whether the user is authorized to access the assets requested by the access request. This may be performed by the communication engine 302. Determining whether the user is authorized may include determining whether a user profile exists for the user (e.g., is this a recognized user) and using the user profile to determine what privileges are associated with the user.

If the determination at 1706 is that the user is not authorized (e.g., the answer is NO), the process 1700 proceeds to 1708 and denies access to the asset. This may be performed by the communication engine 302. As part of denying access, the process 1700 may send a communication to the user device that informs the user why the access request has been denied. For example, the communication may inform the user that the user lacks certain privileges to access the asset.

If the determination at 1706 is that the user is authorized (e.g., the answer is YES), the process 1700 proceeds to 1710 and accesses a data store to retrieve a customized map. This may be performed by the map presentation engine 306 (FIG. 3). Determining which customized map to access may be based at least in part on information in the access request. For example, the access request may identify an upcoming event (e.g., Northwest Wedding Expo) for which an event map has been previously generated.

At 1712, the process 1700 provides the customized map for presentation. This may be performed by the map presentation engine 306. Providing the customized map may include sending information about the customized map for rendering at the user device 106.

At 1714, the process 1700 presents the customized map on a display. This may be performed by the user device 106.

At 1716, the process 1700 initiates a request for reservation of a segment. This may be performed by the user device 106. The request may request reservation of a tenant space segment. In some examples, the request is received by the user selecting an interactive element associated with the tenant space segment.

At 1718, the process 1700 receives the request for reservation of the segment. This may be performed by the communication engine 302.

At 1720, the process 1700 determines whether the segment is free. This may be performed by the reservation engine 312 (FIG. 3). Determining whether segment is free may include accessing a reservation table in a data store to determine whether the reservation state of the segment.

If the determination at 1720 is that the segment is free (e.g., the answer is YES), the process 1700 proceeds to 1722 and indicates the segment as reserved. This may be performed by the reservation engine 312. Indicating that the segment is free may include updating a reservation state in a database.

At 1724, the process 1700 provides an indication of the reserved segment. This may be performed by the communication engine 302.

At 1726, the process 1700 presents the modified map. This may be performed by the user device 106. Presenting the modified map may include presenting the modified map with the segment reserved for the user of the user device 106.

If the determination at 1720 is that the segment is not free (e.g., the answer is NO), the process 1700 proceeds to 1728 and generates a segment suggestion. This may be performed by the reservation engine 312. The segment suggestion may identify one or more segments that are not currently reserved. The segment suggestion may function as a denial communication.

At 1730, the process 1700 provides the segment suggestion. This may be performed by the communication engine 302.

At 1732, the process 1700 presents the segment suggestion. This may be performed by the user device 106. The user of the user device 106 may then determine whether to submit a request for reservation of a segment corresponding to the segment suggestion.

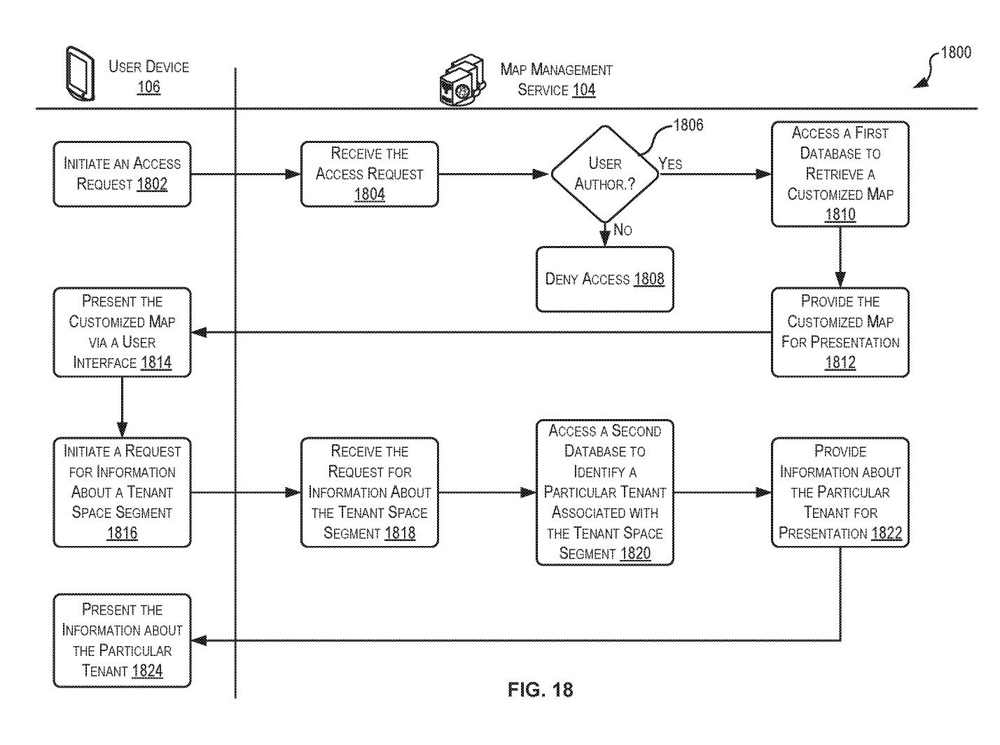

FIG. 18 depicts the process 1800 including example acts or techniques relating to managing customized maps in multi-tenant environments, according to at least one example. The map management engine 216 (FIG. 2) within the map management service 104 (FIG. 1) and in communication with one or more user devices 106 (FIG. 1) may perform the process 1800 of FIG. 18. The process 1800 begins at 1802 by initiating an access request. This may be performed by the user device 106. In some examples, an event attendee operates the user device 106 to initiate the access request. For example, in preparation for an upcoming event and/or during an ongoing event, the event attendee may initiate the access request. The access request may request access to one or more assets of the map management service 104. For example, the access request may request access to a digital mapping environment in which the event tenant can access information associated with tenants associated with tenant space segments in a map for an event. The access request may identify the user associated with the user device 106 by way of a unique user identifier. In some examples, prior to sending the access request, the user may have signed into a website hosted by the map management service 104. In this manner, the map management service 104 may be able to identify the user based on the access request.

At 1804, the process 1800 receives the access request. This may be performed by the communication engine 302 (FIG. 3). The access request may be received from the user device 106. As described above, the map management service 104 may be capable of identifying the user based on the access request. This may include comparing identifying information from the access request with a table of similar information (e.g., the user profile).

At 1806, the process 1800 determines whether the user is authorized to access the assets requested by the access request. This may be performed by the communication engine 302. Determining whether the user is authorized may include determining whether a user profile exists for the user (e.g., is this a recognized user) and using the user profile to determine what privileges are associated with the user.

If the determination at 1806 is that the user is not authorized (e.g., the answer is NO), the process 1800 proceeds to 1808 and denies access to the asset. This may be performed by the communication engine 302. As part of denying access, the process 1800 may send a communication to the user device that informs the user why the access request has been denied. For example, the communication may inform the user that the user lacks certain privileges to access the asset.

If the determination at 1806 is that the user is authorized (e.g., the answer is YES), the process 1800 proceeds to 1810 and accesses a first database to retrieve a customized map. This may be performed by the map presentation engine 306 (FIG. 3). The first database may include a map database. Determining which customized map to access may be based at least in part on information in the access request. For example, the access request may identify an upcoming event (e.g., Northwest Wedding Expo) for which an event map has been previously generated.

At 1812, the process 1800 provides the customized map for presentation. This may be performed by the map presentation engine 306. Providing the customized map may include sending information about the customized map for rendering at the user device 106.

At 1814, the process 1800 presents the customized map via a user interface. This may be performed by the user device 106. In some examples, the user device 106 may be a mobile user device (e.g., a smart phone) and the user interface may be adapted for presenting the customized map on the display of the mobile user device.

At 1816, the process 1800 initiates a request for information about a tenant space segment. This may be performed by the user device 106. The request for information may be received via the user interface, e.g., by selecting an interactive element corresponding to the tenant space segment in the customized map.

At 1818, the process 1800 receives the request for information about the tenant space segment. This may be performed by the communication engine 302.

At 1820, the process 1800 access a second database to identify a particular tenant associated with the tenant space segment. This may be performed by the map generation engine 304. The second database may be a segment database.

At 1822, the process 1800 provides information about the particular tenant for presentation. This may be performed by the communication engine 302. The information about the particular tenant may include information about offerings (e.g., goods and/or services) of the particular tenant. The information may be specific to the event and/or generic to the tenant.

At 1824, the process 1800 presents the information about the particular tenant. This may be performed by the user device 106.

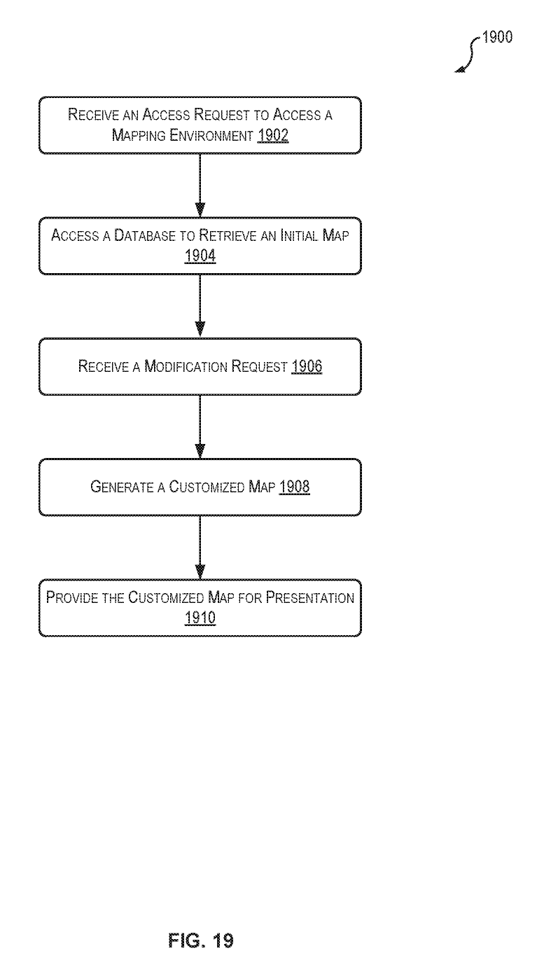

FIG. 19 depicts the process 1900 including example acts or techniques relating to managing customized maps in multi-tenant environments, according to at least one example. The map management engine 216 (FIG. 2) within the map management service 104 (FIG. 1) and in communication with one or more user devices 106 (FIG. 1) may perform the process 1900 of FIG. 19. The process 1900 begins at 1902 by receiving an access request to access a mapping environment. This may be performed by the communication engine 302 (FIG. 3). The mapping environment may include a map generation tool for generating a customized map corresponding to a physical event space. The access request may identify the physical event space.

At 1904, the process 1900 accesses a database to retrieve an initial map. This may be performed by the map presentation engine 306 (FIG. 3). The accessing may be based at least in part on the access request. The initial map may correspond to the physical event space. The initial map may include a boundary of the physical event space and one or more immutable space segments disposed at or within the boundary. The database may include a plurality of initial maps each corresponding to respective physical event spaces. In some examples, the one or more immutable space segments may include one or more of a fixture in the physical event space, an emergency exit in the physical event space, a bathroom in the physical event space, or a designated traffic area in the physical event space.

At 1906, the process 1900 receives a modification request. This may be performed by the communication engine 302. The modification request may be a request to add a tenant space segment to the initial map. The modification request may identify a dimension of the tenant space segment and a desired location of the tenant space segment within the physical event space. The tenant space segment may include a vendor booth. In some examples, the modification request is a first modification request and the customized map is a first customized map. The process 1900 may also include receiving a second modification request to at least add an additional space segment to the first customized map, the additional space segment comprising an additional tenant space segment, a show space segment, a seminar space segment, a chair space segment, or a divider space segment. The process 1900 may also include generating a second customized map by modifying, based at least in part on the second modification request, the first customized map to include the additional space segment positioned at or within the boundary. The process 1900 may also include providing the second customized map for presentation at the user device.

At 1908, the process 1900 generates a customized map. This may be performed by the map generation engine 304 (FIG. 3). Generating the customized map may include modifying, based at least in part on the modification request, the initial map to include the tenant space segment positioned at or within the boundary and apart from the one or more immutable space segments.

At 1910, the process 1900 provides the customized map for presentation at a user device. This may be performed by the map presentation engine 306. In some examples, providing the customized map for presentation at the user device includes enabling the user device to access the customized map from a web server.

In some examples, the modification request is received via the map generation tool and the customized map is generated via the map generation tool. The map generation tool may be a multi-layer map generation tool. The boundary and the one or more immutable space segments may be disposed in a first map layer of the customized map. The tenant space segment may be disposed in a second layer of the customized map.

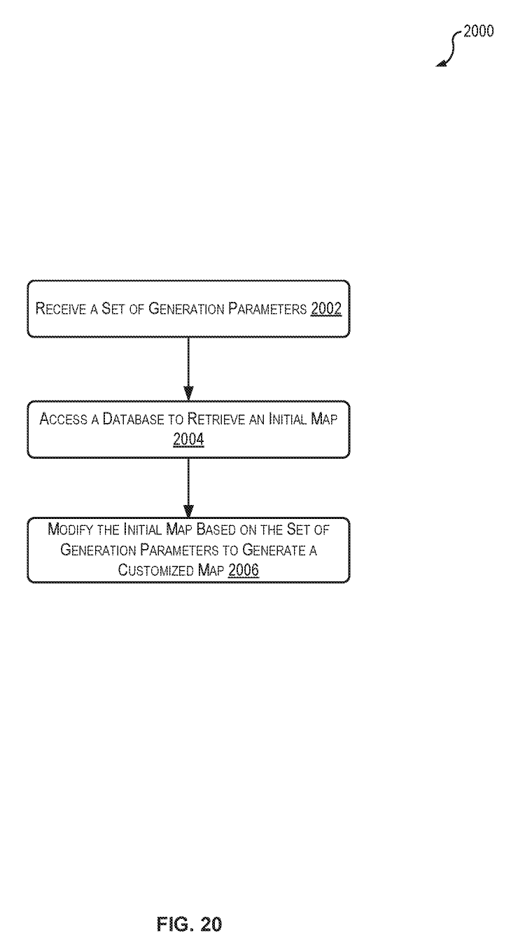

FIG. 20 depicts the process 2000 including example acts or techniques relating to managing customized maps in multi-tenant environments, according to at least one example. The map management engine 216 (FIG. 2) within the map management service 104 (FIG. 1) and in communication with one or more user devices 106 (FIG. 1) may perform the process 2000 of FIG. 20. The process 2000 begins at 2002 by receiving a set of generation parameters. This may be performed by the communication engine 302 (FIG. 3). The set of generation parameters may be used for generating a customized map corresponding to a physical event space. The set of generation parameters may include a quantity parameter identifying a quantity of tenant space segments requested for inclusion in the customized map, a type parameter identifying at least one type of tenant space segment requested for inclusion in the customized map, and/or a dimension parameter identifying at least one set of physical dimensions corresponding to the at least one type of tenant space segment.

At 2004, the process 2000 accesses a database to retrieve an initial map. The initial map may correspond to the physical event space. This may be performed by the map presentation engine 306 (FIG. 3). The initial map may include a boundary of the physical event space and one or more immutable space segments positioned at or within the boundary. The mapping database may include a plurality of initial maps each corresponding to respective physical event spaces.

At 2006, the process 2000 modifies the initial map based on the set of generation parameters to generate a customized map. Generating the initial map may include determining a location for a tenant space segment that is at or within the boundary and that is distinct from locations of the one or more immutable space segments at or within the boundary. Generating the initial map may also include adding the tenant space segment to the initial map at the location. Generating the initial map may also include providing the customized map for presentation via a user interface. The user interface may be provided on a user device. Providing the customized map for presentation via the user interface may include enabling a user device to access, via the user interface, a published version of the customized map including an interactive element corresponding to the tenant space segment.

In some examples, the tenant space segment is a first tenant space segment of a first tenant space type and the location is first location. Generating the customized map may further include determining a second location for a second tenant space segment of a second tenant space type. The second location may be (i) at or within the boundary, (ii) distinct from the locations of the one or more immutable space segments at or within the boundary, and (iii) adjacent to the first location. Generating the customized map may further include adding the second tenant space segment to the initial map at the second location.

In some examples, the process 2000 may further include receiving, via the user interface, information indicating a selection of the interactive element. The process 2000 may further include, in response to receiving the selection, providing information about a tenant associated with the tenant space segment for presentation via the user interface. The information may be at least descriptive of the tenant and an offering of the tenant at the tenant space segment.

In the following, further examples are described to facilitate understanding of the described subject matter:

### Example 1

In this example, there is provided a computer-implemented method comprising:

receiving an access request to access a mapping environment, the mapping environment comprising a map generation tool for generating a customized map corresponding to a physical event space, the access request identifying the physical event space;

accessing, based at least in part on the access request, a database to retrieve an initial map corresponding to the physical event space, the initial map comprising at least a boundary of the physical event space and one or more immutable space segments disposed at or within the boundary, the database comprising a plurality of initial maps each corresponding to respective physical event spaces:

receiving a modification request to at least add a tenant space segment to the initial map, the modification request at least identifying a dimension of the tenant space segment and a location of the tenant space segment within the physical event space;

generating the customized map by modifying, based at least in part on the modification request, the initial map to include the tenant space segment positioned at or within the boundary and apart from the one or more immutable space segments; and

providing the customized map for presentation at a user device.

### Example 2

In this example, there is provided a computer-implemented method of any of the preceding or subsequent examples, wherein:

the modification request is a first modification request and the customized map is a first customized map; and

the method further comprises:
receiving a second modification request to at least add an additional space segment to the first customized map, the additional space segment comprising an additional tenant space segment, a show space segment, a seminar space segment, a chair space segment, or a divider space segment;
generating a second customized map by modifying, based at least in part on the second modification request, the first customized map to include the additional space segment positioned at or within the boundary, and
providing the second customized map for presentation at the user device.

### Example 3

In this example, there is provided a computer-implemented method of any of the preceding or subsequent examples, wherein providing the customized map for presentation at the user device comprises enabling the user device to access the customized map from a web server.

### Example 4

In this example, there is provided a computer-implemented method of any of the preceding or subsequent examples, wherein the one or more immutable space segments comprise one or more of a fixture in the physical event space, an emergency exit in the physical event space, a bathroom in the physical event space, or a designated traffic area in the physical event space.

### Example 5

In this example, there is provided a computer-implemented method of any of the preceding or subsequent examples, wherein the tenant space segment comprises a vendor booth.

### Example 6

In this example, there is provided a computer-implemented method of any of the preceding or subsequent examples, wherein:

the modification request is received via the map generation tool; and

the customized map is generated via the map generation tool.

### Example 7

In this example, there is provided a computer-implemented method of any of the preceding or subsequent examples, wherein:

the map generation tool is a multi-layer map generation tool:

the boundary and the one or more immutable space segments are disposed in a first map layer of the customized map, and

the tenant space segment is disposed in a second layer of the customized map.

### Example 8

In this example, there is provided a system, comprising:

a first database configured to store a plurality of maps corresponding to a plurality of event spaces:

a second database configured to store a plurality of space segment definitions; and

a map service configured to:
receive a set of generation parameters for generating a customized map corresponding to a physical event space;
access the first database to retrieve an initial map corresponding to the physical event space, the initial map comprising a boundary of the physical event space and one or more immutable space segments positioned at or within the boundary;
modify, based at least in part on the set of generation parameters, the initial map to generate the customized map by at least:
   access the second database to retrieve a tenant space segment based at least in part on the set of generation parameters;
   determining a location for a tenant space segment that is at or within the boundary; and
   adding the tenant space segment to the initial map at the location, and provide the customized map for presentation via a user interface.

### Example 9

In this example, there is provided a system of any of the preceding or subsequent examples, wherein providing the customized map for presentation via the user interface comprises enabling a user device to access, via the user interface, a published version of the customized map comprising an interactive element corresponding to the tenant space segment.

### Example 10

In this example, there is provided a system of any of the preceding or subsequent examples, wherein the map service is further configured to:

receive, via selection of the interactive element, a reservation request to reserve the tenant space segment, the reservation request at least identifying a vendor associated with the reservation request;

reserve the tenant space segment by associating the tenant space segment with the vendor; and

provide an indication to the user device that the tenant space segment has been reserved for the vendor.

### Example 11

In this example, there is provided a system of any of the preceding or subsequent examples, wherein:

the tenant space segment corresponds to a set of tenant space segments; and

adding the tenant space segment to the initial map at the location comprises adding other tenant space segments of the set of tenant space segments to the initial map at other locations.

### Example 12

In this example, there is provided a system of any of the preceding or subsequent examples, wherein the one or more immutable space segments comprise one or more of a fixture in the physical event space, an emergency exit in the physical event space, a bathroom in the physical event space, or a designated traffic area in the physical event space.

### Example 13

In this example, there is provided a system of any of the preceding or subsequent examples, wherein providing the customized map for presentation at via the user interface comprises providing access to the customized map hosted by the map service in response to receiving a request for access to the customized map that includes a predefined communication function.

### Example 14

In this example, there is provided a computer-implemented method comprising:

receiving a set of generation parameters for generating a customized map corresponding to a physical event space:

accessing a mapping database to retrieve an initial map corresponding to the physical event space, the initial map comprising a boundary of the physical event space and one or more immutable space segments positioned at or within the boundary, the mapping database comprising a plurality of initial maps each corresponding to respective physical event spaces;

modifying, based at least in part on the set of generation parameters, the initial map to generate the customized map by at least:
determining a location for a tenant space segment that is at or within the boundary and that is distinct from locations of the one or more immutable space segments at or within the boundary; and
adding the tenant space segment to the initial map at the location; and providing the customized map for presentation via a user interface.

### Example 15

In this example, there is provided a computer-implemented method of any of the preceding or subsequent examples, wherein the set of generation parameters comprise at least one of:

a quantity parameter identifying a quantity of tenant space segments requested for inclusion in the customized map;

a type parameter identifying at least one type of tenant space segment requested for inclusion in the customized map; or

a dimension parameter identifying at least one set of physical dimensions corresponding to the at least one type of tenant space segment.

### Example 16

In this example, there is provided a computer-implemented method of any of the preceding or subsequent examples, wherein:

the tenant space segment is a first tenant space segment of a first tenant space type and the location is first location; and

generating the customized map further comprises:
determining a second location for a second tenant space segment of a second tenant space type, the second location being (i) at or within the boundary, (ii) distinct from the locations of the one or more immutable space segments at or within the boundary, and (iii) adjacent to the first location; and
adding the second tenant space segment to the initial map at the second location.

### Example 17

In this example, there is provided a computer-implemented method of any of the preceding or subsequent examples, wherein modifying the initial map to generate the customized map is based at least in part on a profile associated with an event owner.

### Example 18

In this example, there is provided a computer-implemented method of any of the preceding or subsequent examples, wherein the user interface is provided on a user device.

### Example 19

In this example, there is provided a computer-implemented method of any of the preceding or subsequent examples, wherein providing the customized map for presentation via the user interface comprises enabling a user device to access, via the user interface, a published version of the customized map comprising an interactive element corresponding to the tenant space segment.

### Example 20

In this example, there is provided a computer-implemented method of any of the preceding or subsequent examples, further comprising:

receiving, via the user interface, information indicating a selection of the interactive element; and

in response to receiving the selection, providing information about a tenant associated with the tenant space segment for presentation via the user interface, the information at least descriptive of the tenant and an offering of the tenant at the tenant space segment.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”). Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers. Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracles®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media may include computer readable media for containing code, or portions of code, can include any appropriate media known or used in the art, including storage media and communication media, such as, but not limited to, volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology. Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A computer-implemented method comprising:
receiving an access request to access a mapping environment, the mapping environment comprising a map generation tool for generating a customized map corresponding to a physical event space, the access request identifying the physical event space;
accessing, based at least in part on the access request, a database to retrieve an initial map corresponding to the physical event space, the initial map comprising at least a boundary of the physical event space and one or more immutable space segments disposed at or within the boundary, the database comprising a plurality of initial maps each corresponding to respective physical event spaces, the immutable space segments corresponding to elements in the physical event space that lack configurable properties;
receiving a modification request to at least add a tenant space segment to the initial map, the modification request at least identifying a dimension of the tenant space segment and a location of the tenant space segment within the physical event space;
generating the customized map by modifying, based at least in part on the modification request, the initial map to include the tenant space segment positioned at or within the boundary and apart from the one or more immutable space segments; and
providing the customized map for presentation at a user device.

2. The computer-implemented method of claim 1, wherein:
the modification request is a first modification request and the customized map is a first customized map; and
the method further comprises:
receiving a second modification request to at least add an additional space segment to the first customized map, the additional space segment comprising an additional tenant space segment, a show space segment, a seminar space segment, a chair space segment, or a divider space segment;
generating a second customized map by modifying, based at least in part on the second modification request, the first customized map to include the additional space segment positioned at or within the boundary; and
providing the second customized map for presentation at the user device.

3. The computer-implemented method of claim 1, wherein providing the customized map for presentation at the user device comprises enabling the user device to access the customized map from a web server.

4. The computer-implemented method of claim 1, wherein the one or more immutable space segments comprise one or more of a fixture in the physical event space, an emergency exit in the physical event space, a bathroom in the physical event space, or a designated traffic area in the physical event space.

5. The computer-implemented method of claim 4, wherein the tenant space segment comprises a vendor booth.

6. The computer-implemented method of claim 1, wherein:
the modification request is received via the map generation tool; and
the customized map is generated via the map generation tool.

7. The computer-implemented method of claim 6, wherein:
the map generation tool is a multi-layer map generation tool;
the boundary and the one or more immutable space segments are disposed in a first map layer of the customized map; and
the tenant space segment is disposed in a second layer of the customized map.

8. A system, comprising:
a first database configured to store a plurality of maps corresponding to a plurality of event spaces;
a second database configured to store a plurality of space segment definitions; and
a map service in communication with the first database and the second database, and configured to:
receive a set of generation parameters for generating a customized map corresponding to a physical event space;
access the first database to retrieve an initial map corresponding to the physical event space, the initial map comprising a boundary of the physical event space and one or more immutable space segments positioned at or within the boundary;
modify, based at least in part on the set of generation parameters, the initial map to generate the customized map by at least:
accessing the second database to retrieve a tenant space segment based at least in part on the set of generation parameters;
determining a location for the tenant space segment that is at or within the boundary; and
adding the tenant space segment to the initial map at the location; and
provide the customized map for presentation via a user interface.

9. The system of claim 8, wherein providing the customized map for presentation via the user interface comprises enabling a user device to access, via the user interface, a published version of the customized map comprising an interactive element corresponding to the tenant space segment.

10. The system of claim 9, wherein the map service is further configured to:
receive, via selection of the interactive element, a reservation request to reserve the tenant space segment, the reservation request at least identifying a vendor associated with the reservation request;
reserve the tenant space segment by associating the tenant space segment with the vendor; and
provide an indication to the user device that the tenant space segment has been reserved for the vendor.

11. The system of claim 8, wherein:
the tenant space segment corresponds to a set of tenant space segments; and
adding the tenant space segment to the initial map at the location comprises adding other tenant space segments of the set of tenant space segments to the initial map at other locations.

12. The system of claim 8, wherein the one or more immutable space segments comprise one or more of a fixture in the physical event space, an emergency exit in the physical event space, a bathroom in the physical event space, or a designated traffic area in the physical event space.

13. The system of claim 8, wherein providing the customized map for presentation via the user interface comprises providing access to the customized map hosted by the map service in response to receiving a request for access to the customized map that includes a predefined communication function.

14. A computer-implemented method comprising:
receiving a set of generation parameters for generating a customized map corresponding to a physical event space;
accessing a mapping database to retrieve an initial map corresponding to the physical event space, the initial map comprising a boundary of the physical event space and one or more immutable space segments positioned at or within the boundary, the mapping database comprising a plurality of initial maps each corresponding to respective physical event spaces;
modifying, based at least in part on the set of generation parameters, the initial map to generate the customized map by at least:
determining a location for a tenant space segment that is at or within the boundary and that is distinct from locations of the one or more immutable space segments at or within the boundary; and
adding the tenant space segment to the initial map at the location; and
providing the customized map for presentation via a user interface.

15. The computer-implemented method of claim 14, wherein the set of generation parameters comprise at least one of:
a quantity parameter identifying a quantity of tenant space segments requested for inclusion in the customized map;
a type parameter identifying at least one type of tenant space segment requested for inclusion in the customized map; or
a dimension parameter identifying at least one set of physical dimensions corresponding to the tenant space segment.

16. The computer-implemented method of claim 14, wherein:
the tenant space segment is a first tenant space segment of a first tenant space type and the location is a first location; and
generating the customized map further comprises:
determining a second location for a second tenant space segment of a second tenant space type, the second location being (i) at or within the boundary, (ii) distinct from the locations of the one or more immutable space segments at or within the boundary, and (iii) adjacent to the first location; and
adding the second tenant space segment to the initial map at the second location.

17. The computer-implemented method of claim 14, wherein modifying the initial map to generate the customized map is based at least in part on a profile associated with an event owner.

18. The computer-implemented method of claim 14, wherein the user interface is provided on a user device.

19. The computer-implemented method of claim 14, wherein providing the customized map for presentation via the user interface comprises enabling a user device to access, via the user interface, a published version of the customized map comprising an interactive element corresponding to the tenant space segment.

20. The computer-implemented method of claim 19, further comprising:
receiving, via the user interface, information indicating a selection of the interactive element; and
in response to receiving the selection, providing information about a tenant associated with the tenant space segment for presentation via the user interface, the information at least descriptive of the tenant and an offering of the tenant at the tenant space segment.
